(19) United States
(12) Patent Application Publication
(10) Pub. No.: US 2002/0155041 A1
(43) Pub. Date: Oct. 24, 2002

(54) Electro-kinetic air transporter-conditioner with non-equidistant collector electrodes

(76) Inventors: Edward C. McKinney JR., San Rafael, CA (US); Charles E. Taylor, Sebastopol, CA (US); Jim L. Lee, Rohnert Park, CA (US)

Correspondence Address: Sheldon R. Meyer, Esq., FLIESLER DUBB MEYER & LOVEJOY LLP, Fourth Floor, Four Embarcadero Center, San Francisco, CA, 94111-4156, US

(21) Appl. No.: 10/074,827

(22) Filed: Feb. 12, 2002

Related U.S. Application Data
(63) Continuation-in-part of application No. 09/924,624, filed on Aug. 8, 2001.
(63) Continuation of application No. 09/564,960, filed on May 4, 2000, now Pat. No. 6,350,417.
(63) Continuation-in-part of application No. 09/186,471, filed on Nov. 5, 1998, now Pat. No. 6,176,977.
(60) Provisional application No. 60/341,176, filed on Dec. 13, 2001.
(60) Provisional application No. 60/306,479, filed on Jul. 18, 2001.

(51) Int. Cl. B01J 19/08

(52) U.S. Cl. 422/186.04

(57) ABSTRACT

An electro-kinetic air transporter-conditioner creates airflow with an electrode assembly that includes a first array of electrodes and a second array of electrodes. The innermost electrodes of the second array are preferably located further away from the first array than the outermost electrodes in the second array. This non-equidistant configuration equalizes the electrical fields created at the tip of each electrode within the second array. Reducing the electrical field at the innermost electrodes also reduces the amount of ozone generated by the device.

### CLAIM OF PRIORITY

This application claims priority from provisional application entitled “ELECTRO-KINETIC AIR TRANSPORTER-CONDITIONER WITH NON-EQUIDISTANT COLLECTOR ELECTRODES ,” U.S. patent application Ser. No. 60/341,176, filed Dec. 13, 2001 under 35 U.S.C. 119(e), which application is incorporated herein by reference. This application claims priority from provisional application entitled “FOCUS ELECTRODE, ELECTRO-KINETIC AIR TRANSPORTER-CONDITIONER DEVICES,” U.S. patent application Ser. No. 60/306,479, filed Jul. 18, 2001 under 35 U.S.C. 119(e), which application is incorporated herein by reference. This application claims priority from and is a continuation-in-part of U.S. patent application Ser. No. 09/924,624 filed Aug. 8,2001 which is a continuation of U.S. patent application Ser. No. 09/564,960 filed May 4, 2000, which is a continuation-in-part of U.S. patent application Ser. No. 09/186,471 filed Nov. 5,1998, now U.S. Pat. No. 6,176,977. All of the above are incorporated herein by reference.

### CROSS-REFERENCE TO RELATED APPLICATIONS

1. U.S. patent application Ser. No. 60/341,518, filed Dec. 13,2001, entitled “ELECTRO-KINETIC AIR TRANSPORTER-CONDITIONER DEVICES WITH AN UPSTREAM FOCUS ELECTRODE”; SHPR-01041US6

2. U.S. patent application Ser. No. 60/341,090, filed Dec. 13,2001, entitled “ELECTRO-KINETIC AIR TRANSPORTER-CONDITIONER DEVICES WITH TRAILING ELECTRODE”; SHPR-01041USE

3. U.S. patent application Ser. No. 60/341,433, filed Dec. 13,2001, entitled “ELECTRO-KINETIC AIR TRANSPORTER-CONDITIONER DEVICES WITH INTERSTITIAL ELECTRODE”; SHPR-01041USF

4. U.S. patent application Ser. No. 60/341,592, filed Dec. 13,2001, entitled “ELECTRO-KINETIC AIR TRANSPORTER-CONDITIONER DEVICES WITH ENHANCED COLLECTOR ELECTRODE”; SHPR-01041USG

5. U.S. patent application Ser. No. 60/341,320, filed Dec. 13,2001, entitled “ELECTRO-KINETIC AIR TRANSPORTER-CONDITIONER DEVICES WITH ENHANCED EMITTER ELECTRODE”; SHPR-01041USH

6. U.S. patent application Ser. No. 60/341,179, filed Dec. 13,2001, entitled “ELECTRO-KINETIC AIR TRANSPORTER AND CONDITIONER DEVICE WITH ENHANCED ANTI-MICROORGANISM CAPABILITY”; SHPR-01028US 1

7. U.S. patent application Ser. No. 60/340,702, filed Dec. 13,2001, entitled “ELECTRO-KINETIC AIR TRANSPORTER AND CONDITIONER DEVICE WITH ENHANCED HOUSING CONFIGURATION AND ENHANCED ANTI-MICROORGANISM CAPABILITY”; SHPR-01028US2

8. U.S. patent application Ser. No. 60/341,377, filed Dec. 13,2001, entitled “ELECTRO-KINETIC AIR TRANSPORTER AND CONDITIONER DEVICE WITH ENHANCED MAINTENANCE FEATURES AND ENHANCED ANTI-MICROORGANISM CAPABILITY”; SHPR-01028US3

9. U.S. patent application Ser. No. 10/023,197, filed Dec. 13,2001, entitled “ELECTRO-KINETIC AIR TRANSPORTER-CONDITIONER DEVICE WITH ENHANCED CLEANING FEATURES”; SHPR-01041USI

10. U.S. patent application Ser. No. 10/023,460, filed Dec. 13,2001, entitled “ELECTRO-KINETIC AIR TRANSPORTER-CONDITIONER WITH PIN-RING ELECTRODE CONFIGURATION”; SHPR-01041USJ

11. U.S. patent application Ser. No. 60/340,288, filed Dec. 13,2001, entitled “DUAL INPUT AND OUTLET ELECTROSTATIC AIR TRANSPORTER-CONDITIONER”; SHPR-01041US7 and

12. U.S. patent application Ser. No. 60/340,462, filed Dec. 13,2001, entitled “ELECTRO-KINETIC AIR TRANSPORTER-CONDITIONER DEVICES WITH A ENHANCED COLLECTOR ELECTRODE FOR COLLECTION OF MORE PARTICULATE MATTER”. SHPR-01041US9

13. U.S. patent application Ser. No. 10/______ , filed herewith, entitled “ELECTRO-KINETIC AIR TRANSPORTER-CONDITIONER DEVICES WITH AN UPSTREAM FOCUS ELECTRODE”; SHPR-01041USL

14. U.S. patent application Ser. No. 10/______ , filed herewith, entitled “ELECTRO-KINETIC AIR TRANSPORTER-CONDITIONER DEVICES WITH TRAILING ELECTRODE”; SHPR-01041USM

15. U.S. patent application Ser. No. 10/______ , filed herewith, entitled “ELECTRO-KINETIC AIR TRANSPORTER-CONDITIONER DEVICES WITH INTERSTITIAL ELECTRODE”; SHPR-01041USN

16. U.S. patent application Ser. No. 10/______ , filed herewith, entitled “ELECTRO-KINETIC AIR TRANSPORTER-CONDITIONER DEVICES WITH ENHANCED COLLECTOR ELECTRODE”; SHPR-01041USO

17. U.S. patent application Ser. No. 10/______ , filed herewith, entitled “ELECTRO-KINETIC AIR TRANSPORTER-CONDITIONER DEVICES WITH ENHANCED EMITTER ELECTRODE”; SHPR-01041USP

18. U.S. patent application Ser. No. 10/______ , filed herewith, entitled “ELECTRO-KINETIC AIR TRANSPORTER AND CONDITIONER DEVICE WITH ENHANCED ANTI-MICROORGANISM CAPABILITY”; SHPR-01028US4

19. U.S. patent application Ser. No. 10/______ , filed herewith entitled “ELECTRO- KINETIC AIR TRANSPORTER AND CONDITIONER DEVICE WITH ENHANCED HOUSING CONFIGURATION AND ENHANCED ANTI-MICROORGANISM CAPABILITY”; SHPR-01028US5

20. U.S. patent application Ser. No. 10/______ , filed herewith, entitled “ELECTRO-KINETIC AIR TRANSPORTER AND CONDITIONER DEVICE WITH ENHANCED MAINTENANCE FEATURES AND ENHANCED ANTI-MICROORGANISM CAPABILITY”; SHPR-01028US6

21. U.S. patent application Ser. No. 10/______ ,filed herewith, entitled “DUAL INPUT AND OUTLET ELECTROSTATIC AIR TRANSPORTER-CONDITIONER”; SHPR01041USR and

22. U.S. patent application Ser. No. 10/______ , filed herewith, entitled “ELECTRO-KINETIC AIR TRANSPORTER-CONDITIONER DEVICES WITH A ENHANCED COLLECTOR ELECTRODE FOR COLLECTION OF MORE PARTICULATE MATTER”. SHPR-01041USS.

All of the above are incorporated herein by reference.

### FIELD OF THE INVENTION

This invention relates generally to devices that produce an electro-kinetic flow of air, from which particulate matter has been substantially removed.

### BACKGROUND OF THE INVENTION

The use of an electric motor to rotate a fan blade to create an airflow has long been known in the art. Unfortunately, such fans produce substantial noise, and can present a hazard to children who maybe tempted to poke a finger or a pencil into the moving fan blade. Although such fans can produce substantial airflow, e.g., 1,000 ft³/minute or more, substantial electrical power is required to operate the motor, and essentially no conditioning of the flowing air occurs.

It is known to provide such fans with a HEPA-compliant filter element to remove particulate matter larger than perhaps 0.3 μm. Unfortunately, the resistance to airflow presented by the filter element may require doubling the electric motor size to maintain a desired level of airflow. Further, HEPA-compliant filter elements are expensive, and can represent a substantial portion of the sale price of a HEPA-compliant filter-fan unit. While such filter-fan units can condition the air by removing large particles, particulate matter small enough to pass through the filter element is not removed, including bacteria, for example.

It is also known in the art to produce an airflow using electro-kinetic techniques, by which electrical power is directly converted into a flow of air without mechanically moving components. One such system is described in U.S. Pat. No. 4,789,801 issued to Lee (1988), which is incorporated herein by reference. The '801 patent describes various devices to generate a stream of ionized air using so-called electro-kinetic techniques. In some applications, the electro-kinetic devices may be small enough to be handheld, and in other applications electro-kinetic devices maybe large enough to condition the air in a room. In overview, electro-kinetic techniques use high electric fields to ionize air molecules, a process that may produce ozone (O₃) as a byproduct. Ozone is an unstable molecule of oxygen that is commonly produced as a byproduct of high voltage arcing. In appropriate concentrations, ozone can be a desirable and useful substance. But ozone by itself may not be effective to kill microorganisms such as germs, bacteria, and viruses in the environment surrounding the device.

FIG. 1 depicts a generic electro-kinetic device 10 to condition air. Device 10 includes a housing 20 that typically has at least one air input port 30 and at least one air output port 40. Within housing 20 there is disposed an electrode assembly or system 50 comprising a first electrode array 60 having at least one electrode 70 and comprising a second electrode array 80 having at least one electrode 90. System 10 further includes a high voltage generator 95 coupled between the first and second electrode arrays.

As a result, ozone and ionized particles of air are generated within device 10, and there is an electro-kinetic flow of air in the direction from the first electrode array 60 towards the second electrode array 80. In FIG. 1, the large arrow denoted IN represents ambient air that can enter input port 30. The small “x's” denote particulate matter that maybe present in the incoming ambient air. The air movement is in the direction of the large arrows, and the output airflow, denoted OUT, exits device 10 via port 40. An advantage of electro-kinetic devices such as device 10 is that an airflow is created without using fans or other moving parts to create the airflow.

Preferably, particulate matter in the ambient air can be electrostatically attracted to the second electrode array 80, with the result that the outflow (OUT) of air from device 10 not only contains ozone and ionized air, but can be cleaner than the ambient air. Thus, device 10 in FIG. 1 can function somewhat as a fan to create an output airflow, but without requiring moving parts.

Ideally the outflow of air (OUT) is conditioned in that particulate matter is removed and the outflow includes appropriate amounts of ozone, and some ions.

As shown in FIG. 2A, system 50 includes an array of first (“emitter”) electrodes or conductive surfaces 70 that are spaced-apart symmetrically from an array of second (“collector”) electrodes or conductive surfaces 90. The positive terminal of a generator such as, for example, pulse generator 95 that outputs a train of high voltage pulses (e.g., 0 to perhaps +5 KV) is coupled to the first array, and the negative pulse generator terminal is coupled to the second array in this example. It is to be understood that the arrays depicted include multiple electrodes, but that an array can include or be replaced by a single electrode.

The high voltage pulses ionize the air between the arrays, and create an airflow from the first array toward the second array, without requiring any moving parts. Particulate matter 60 in the air is entrained within the airflow and also moves towards the second electrodes 90. Much of the particulate matter 60 is electrostatically attracted to the surfaces of the second electrodes 90, where it remains, thus conditioning the flow of air exiting system 50. Further, the high voltage field present between the electrode arrays can release ozone into the ambient environment, which can eliminate odors that are entrained in the airflow.

In the particular embodiment of FIG. 2A, first electrodes 70 are circular in cross-section, having a diameter of about 0.003″ (0.08 mm), whereas the second electrodes 90 are substantially larger in area and define a “teardrop” shape in cross-section. The ratio of cross-sectional radii of curvature between the bulbous front nose of the second electrode and the first electrodes exceeds 10:1. As shown in FIG. 2A, the bulbous front surfaces of the second electrodes 90 face the first electrodes 70, and the somewhat “sharp” trailing edges face the exit direction of the airflow. The “sharp” trailing edges on the second electrodes 90 promote good electrostatic attachment of particulate matter entrained in the airflow.

In another particular embodiment shown herein as FIG. 2B, second electrodes 90 are symmetrical and elongated in cross-section. The elongated trailing edges on the second electrodes 90 provide increased area upon which particulate matter entrained in the airflow can attach.

While the electrostatic techniques disclosed by the '801 patent are advantageous over conventional electric fan-filter units, further increased air transport-conditioning efficiency would be advantageous.

### SUMMARY OF THE INVENTION

An aspect of an embodiment of the present invention is to provide an electro-kinetic system for transporting and conditioning air without moving parts. An embodiment includes an ion generator comprising first and second conducting electrodes or surfaces. The first and second electrodes are coupled to output ports of a high voltage generator.

Another aspect of an embodiment of the present invention is to remove dust and other particulate matter from the airflow. The dust and particulate matter attaches electrostatically to the second electrodes, and the output air is substantially clean of such particulate matter.

Yet another aspect of the present invention is to produce ozone to reduce or kill certain types of germs and the like. Ozone is also beneficial for eliminating odors in the output air. An embodiment of the invention permits the user to temporarily increase the high voltage pulse generator output which creates more ozone, e.g., to more rapidly eliminate odors in the environment.

Still another aspect of an embodiment of the present invention is to increase the airflow rate of the device while not increasing the amount of ozone output into the atmosphere. An embodiment includes a second array of electrodes, or collector electrodes, where several of the second electrodes are recessed back, further away from the first array of electrodes. This configuration can reduce the amount of high-voltage arcing within the ion generator, which can produce ozone.

Other features and advantages of the invention will appear from the following description in which the preferred embodiments have been set forth in detail, in conjunction with the accompanying drawings, and also from the following claims.

### BRIEF DESCRIPTION OF THE DRAWINGS

FIG. 1 is a schematic of prior-art electro-kinetic device with an electrode assembly;

FIGS. 2A-2B; FIG. 2A is a plan view of a first and second electrode arrays of a prior art electrode assembly; FIG. 2B is a plan view of another embodiment of first and second electrode arrays according to a prior art electrode assembly;

FIGS. 3A-3B; FIG. 3A is a perspective view of an embodiment of the housing of the present invention; FIG. 3B is a perspective view of the housing shown in FIG. 3A, illustrating a removable array of second electrodes;

FIG. 4 is an electrical block diagram of an embodiment of the ion generator assembly, according to the present invention;

FIGS. 5A-5D; FIG. 5A is a perspective view illustrating an embodiment for an electrode assembly of the present invention; FIG. 5B is a plan view of the electrode assembly shown in FIG. 5A; FIG. 5C is a perspective view of another embodiment of an electrode assembly of the present invention; FIG. 5D is a plan view of yet another embodiment of an electrode assembly of the present invention;

FIGS. 6A-6F; FIG. 6A is a perspective view of an embodiment of the electrode assembly, according to the present invention; FIG. 6B is a plan view of the embodiment illustrated in FIG. 6A; FIG. 6C is a perspective view of another embodiment of the electrode assembly, according to the present invention; FIG. 6D is a plan view of another embodiment of the present invention; FIG. 6E is a perspective view of still another embodiment of the electrode assembly, according to the present invention; FIG. 6F is a plan view of an alternative embodiment of the invention;

FIGS. 7A-7B; FIG. 7A is a perspective view of yet another embodiment of the electrode assembly, according to the present invention; FIG. 7B is a plan view of the embodiment shown in FIG. 7A;

FIGS. 8A-8C; FIG. 8A is a plan view of another embodiment of the electrode assembly, according to the present invention; FIG. 8B is a plan view of yet another embodiment of the present invention; FIG. 8C is a plan view of a modified embodiment of that shown in FIG. 8B;

FIGS. 9A-9B; FIG. 9A is a perspective view of still another embodiment of the electrode assembly; FIG. 9B is a perspective view of a modified embodiment of that shown in FIG. 9A;

FIGS. 10A-10F; FIG. 10A is a plan view of another embodiment of the electrode assembly of the present invention; FIG. 10B is a plan view of a modified embodiment of that shown in FIG. 10A; FIG. 10C is a plan view of yet another embodiment of the electrode assembly, according to the present invention; FIG. 10D is a plan view of a modified embodiment of that shown in FIG. 10C; FIG. 10D is a plan view of yet another embodiment of the electrode assembly of the present invention; FIG. 10F is a plan view of a modified embodiment of the electrode assembly as shown in FIG. 10E;

FIGS. 11A-11C; FIG. 11A is a perspective view of yet another embodiment of the electrode assembly of the present invention; FIG. 11B is a perspective view of another embodiment of the electrode assembly of the present invention; FIG. 11C is a perspective view of still another embodiment of the electrode assembly of the present invention;

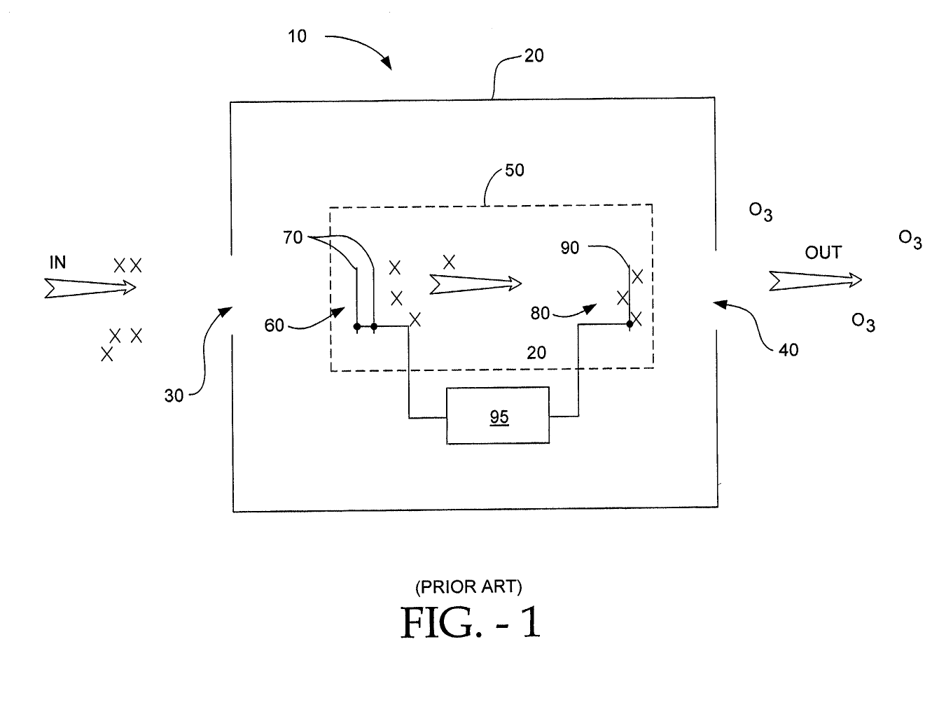

### DETAILED DESCRIPTION OF THE PREFERRED EMBODIMENT

Overall Air Transporter-Conditioner Device Configuration

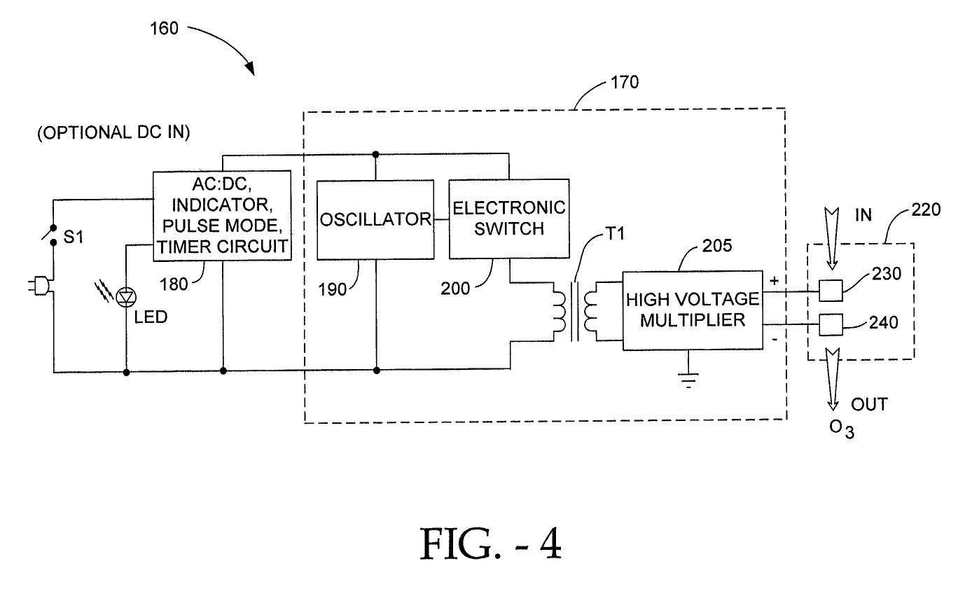

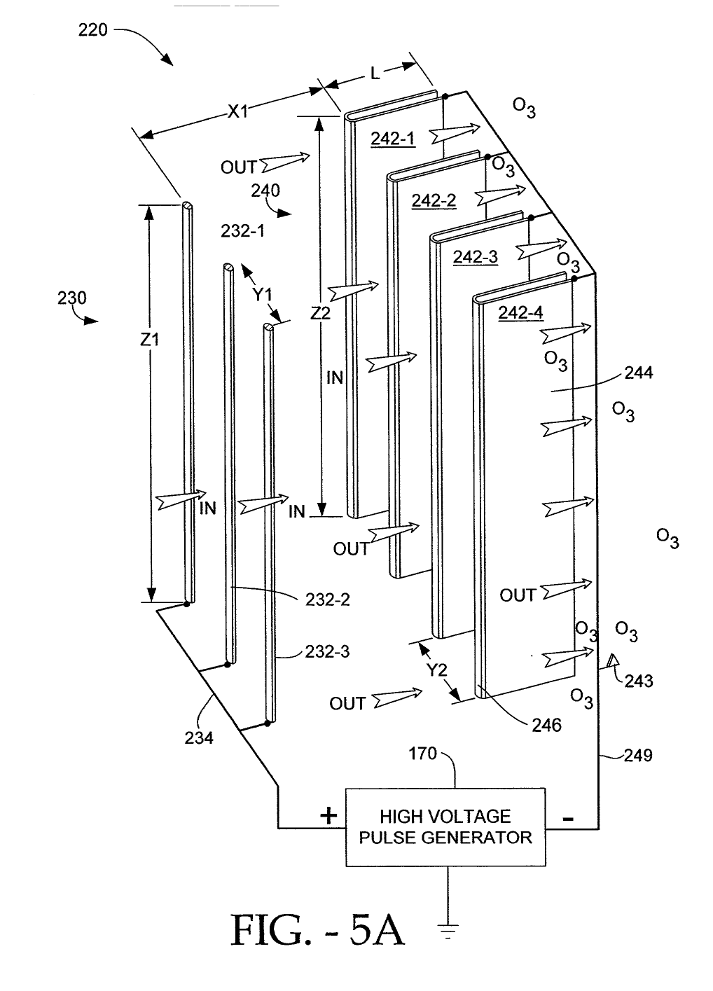

FIGS. 3A and 3B depict an electro-kinetic air transporter-conditioner system 100 whose housing 102 includes preferably rear-located intake vents or louvers 104 and preferably front located exhaust vents 106, and a base pedestal 108. Preferably the housing is freestanding and/or upstandingly vertical and/or elongated. Internal to the transporter housing is an ion generating unit 160, preferably powered by an AC:DC power supply that is energizable or excitable using switch S1. S1, which along with the other below described user operated switches are conveniently located at the top 103 of the unit 100. Ion generating unit 160 is self-contained in that other ambient air, nothing is required from beyond the transporter housing, save external operating potential, for operation of the present invention.

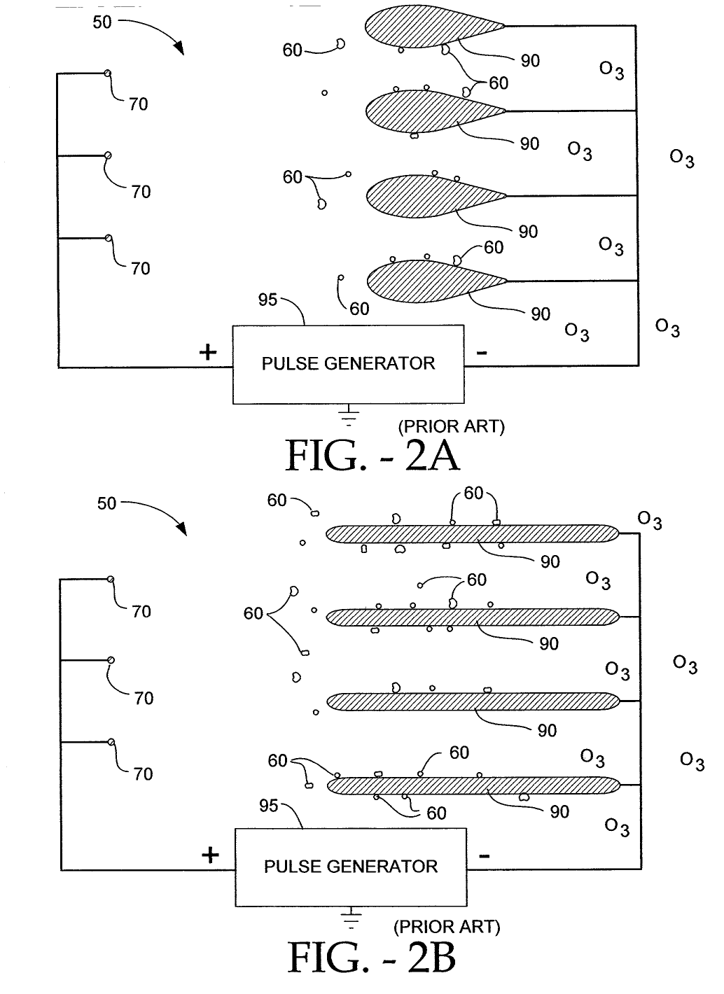

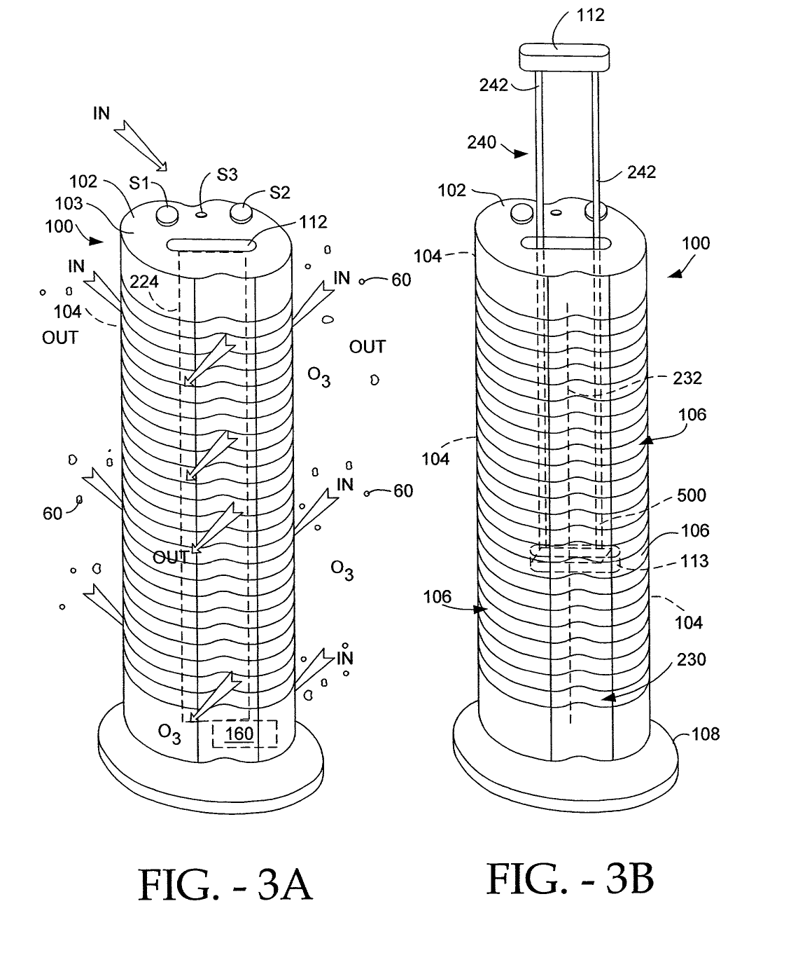

The upper surface of housing 102 includes a user-liftable handle member 112 to which is affixed a second array 240 of collector electrodes 242 within an electrode assembly 220. Electrode assembly 220 also comprises a first array of emitter electrodes 230, or a single first electrode shown here as a single wire or wire-shaped electrode 232. (The terms “wire” and “wire-shaped” shall be used interchangeably herein to mean an electrode either made from a wire or, if thicker or stiffer than a wire, having the appearance of a wire.) In the embodiment shown, lifting member 112 lifts second array electrodes 240 upward, causing the second electrode to telescope out of the top of the housing and, if desired, out of unit 100 for cleaning, while the first electrode array 230 remains within unit 100. As is evident from the figure, the second array of electrode can be lifted vertically out from the top 103 of unit 100 along the longitudinal axis or direction of the elongated housing 102. This arrangement with the second electrodes removable from the top 103 of the unit 100, makes it easy for the user to pull the second electrodes out for cleaning. In FIG. 2B, the bottom ends of second electrodes 242 are connected to a member 113, to which is attached a mechanism 500, which includes a flexible member and a slot for capturing and cleaning the first electrode 232, whenever handle member 112 is moved upward or downward by a user.

The general shape of the embodiment of the invention shown in FIGS. 3A and 3B is that of a figure eight in cross-section, although other shapes are within the spirit and scope of the invention. The top-to-bottom height of the preferred embodiment is in one preferred embodiment, 1 m, with a left-to-right width of preferably 15 cm, and a front-to-back depth of perhaps 10 cm, although other dimensions and shapes can of course be used. A louvered construction provides ample inlet and outlet venting in an economical housing configuration. There need be no real distinction between vents 104 and 106, except their location relative to the second electrodes. These vents serve to ensure that an adequate flow of ambient air can be drawn into or made available to the unit 100, and that an adequate flow of ionized air that includes appropriate amounts of O₃ flows out from unit 100.

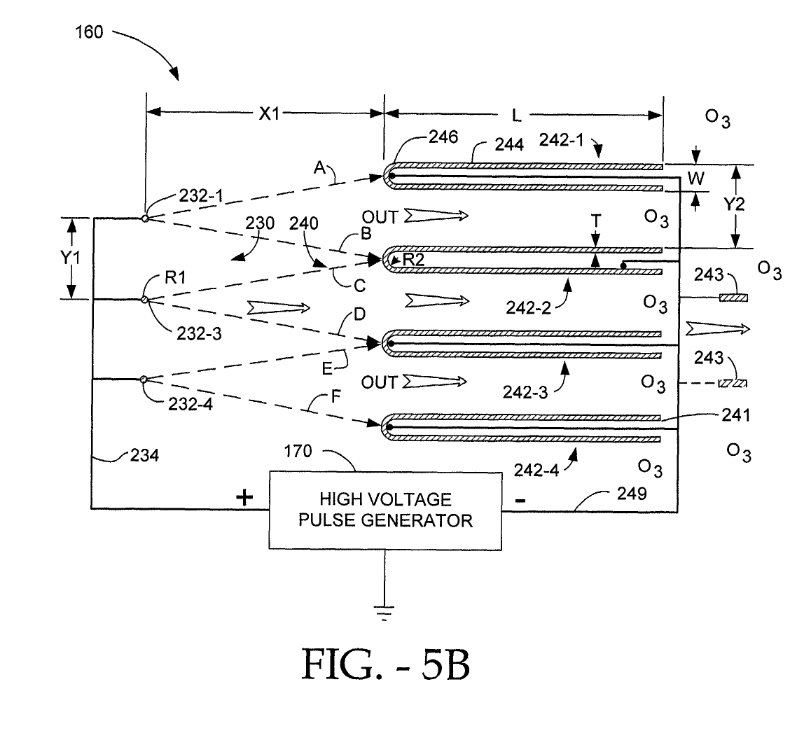

The first and second arrays of electrodes are coupled to the output terminals of ion generating unit 160, as best seen in FIG. 4. As will be described, when unit 100 is energized with S1, high voltage or high potential output by ion generator 160 produces ions at the first electrode, which ions are attracted to the second electrodes. The movement of the ions in an “IN” to “OUT” direction carries with the ions air molecules, thus electro-kinetically producing an outflow of ionized air. The “IN” notation in FIGS. 3A and 3B denote the intake of ambient air with particulate matter 60. The “OUT” notation in the figures denotes the outflow of cleaned air substantially devoid of the particulate matter, which particulates matter adheres electrostatically to the surface of the second electrodes. In the process of generating the ionized airflow appropriate amounts of ozone (O₃) are beneficially produced. It may be desired to provide the inner surface of housing 102 with an electrostatic shield to reduces detectable electromagnetic radiation. For example, a metal shield could be disposed within the housing, or portions of the interior of the housing can be coated with a metallic paint to reduce such radiation.

As best seen in FIG. 4, ion generating unit 160 includes a high voltage generator unit 170 and circuitry 180 for converting raw alternating voltage (e.g., 117 VAC) into direct current (“DC”) voltage. Circuitry 180 preferably includes circuitry controlling the shape and/or duty cycle of the generator unit output voltage (which control is altered with user switch S2). Circuitry 180 preferably also includes a pulse mode component, coupled to switch S3, to temporarily provide a burst of increased output ozone. Circuitry 180 can also include a timer circuit and a visual indicator such as alight emitting diode (“LED”). The LED or other indicator (including, if desired, an audible indicator) signals when ion generation quits occurring. The timer can automatically halt generation of ions and/or ozone after some predetermined time, e.g., 30 minutes.

The high voltage generator unit 170 preferably comprises a low voltage oscillator circuit 190 of perhaps 20 KHz frequency, that outputs low voltage pulses to an electronic switch 200, e.g., a thyristor or the like. Switch 200 switchably couples the low voltage pulses to the input winding of a step-up transformer T1. The secondary winding of T1 is coupled to a high voltage multiplier circuit 210 that outputs high voltage pulses. Preferably the circuitry and components comprising high voltage pulse generator 170 and circuit 180 are fabricated on a printed circuit board that is mounted within housing 102. If desired, external audio input (e.g., from a stereo tuner) could be suitably coupled to oscillator 190 to acoustically modulate the kinetic airflow produced by unit 160. The result would be an electrostatic loudspeaker, whose output airflow is audible to the human ear in accordance with the audio input signal. Further, the output air stream would still include ions and ozone.

Output pulses from high voltage generator 170 preferably are at least 10 KV peak-to-peak with an effective DC offset of, for example, half the peak-to-peak voltage, and have a frequency of, for example, 20 KHz. Frequency of oscillation can include other values, but frequency of at least about 20 KHz is preferred as being inaudible to humans. If pets will be in the same room as the unit 100, it maybe desired to utilize and even higher operating frequency, to prevent pet discomfort and/or howling by the pet. The pulse train output preferably has a duty cycle of for example 10%, which will promote battery lifetime if live current is not used. Of course, different peak-peak amplitudes, DC offsets, pulse train wave-shapes, duty cycle, and/or repetition frequencies can be used instead. Indeed, a 100% pulse train (e.g., an essentially DC high voltage) maybe used, albeit with shorter battery lifetime. Thus, generator unit 170 for this embodiment can be referred to as a high voltage pulse generator. Unit 170 functions as a DC:DC high voltage generator, and could be implemented using other circuitry and/or techniques to output high voltage pulses that are input to electrode assembly 220.

As noted, outflow (OUT) preferably includes appropriate amounts of ozone that can remove odors and preferably destroy or at least substantially alter bacteria, germs, and other living (or quasi-living) matter subjected to the outflow. Thus, when switch S1 is closed and the generator 170 has sufficient operating potential, pulses from high voltage pulse generator unit 170 create an outflow (OUT) of ionized air and ozone. When S1 is closed, LED will visually signal when ionization is occurring.

Preferably operating parameters of unit 100 are set during manufacture and are generally not user-adjustable. For example, with respect to operating parameters, increasing the peak-to-peak output voltage and/or duty cycle in the high voltage pulses generated by unit 170 can increase the airflow rate, ion content, and ozone content. These parameters can be set by the user by adjusting switch S2 as disclosed below. In the preferred embodiment, output flowrate is about 200 feet/minute, ion content is about 2,000,000/cc and ozone content is about 40 ppb (over ambient) to perhaps 2,000 ppb (over ambient). Decreasing the ratio of the radius of the nose of the second electrodes to the radius of the first electrode or decreasing the ratio of the cross-sectioned area of the second electrode to the first electrode below about 20:1 will decrease flow rate, as will decreasing the peak-to-peak voltage and/or duty cycle of the high voltage pulses coupled between the first and second electrode arrays.

In practice, unit 100 is placed in a room and connected to an appropriate source of operating potential, typically 117 VAC. With S1 energizing ionization unit 160, systems 100 emits ionized air and preferably some ozone via outlet vents 106. The airflow, coupled with the ions and ozone freshens the air in the room, and the ozone can beneficially destroy or at least diminish the undesired effects of certain odors, bacteria, germs, and the like. The airflow is indeed electro-kinetically produced, in that there are no intentionally moving parts within unit 100. (Some mechanical vibration may occur within the electrodes.).

Having described various aspects of this embodiment of the invention in general, preferred embodiments of electrode assembly 220 are now described. In the various embodiments, electrode assembly 220 comprises a first array 230 of at least one electrode or conductive surface 232, and further comprises a second array 240 of at least one electrode or conductive surface 242. Understandably materials for electrodes 232 and 242 should conduct electricity, be resistant to corrosive effects from the application of high voltage, yet be strong enough to be cleaned.

In the various electrode assemblies to be described herein, electrodes 232 in the first electrode array 230 are preferably fabricated from tungsten. Tungsten is sufficiently robust in order to withstand cleaning, has a high melting point to retard breakdown due to ionization, and has a rough exterior surface that seems to promote efficient ionization. On the other hand, electrodes 242 preferably have a highly polished exterior surface to minimize unwanted point-to-point radiation. As such, electrodes 242 preferably are fabricated from stainless steel and/or brass, among other materials. The polished surface of electrodes 232 also promotes ease of electrode cleaning.

In contrast to the prior art electrodes disclosed by the '801 patent, electrodes 232 and 242, are light weight, easy to fabricate, and lend themselves to mass production. Further, electrodes 232 and 242 described herein promote more efficient generation of ionized air, and appropriate amounts of ozone, (indicated in several of the figures as O₃).

Electrode Assembly with First and Second Electrodes

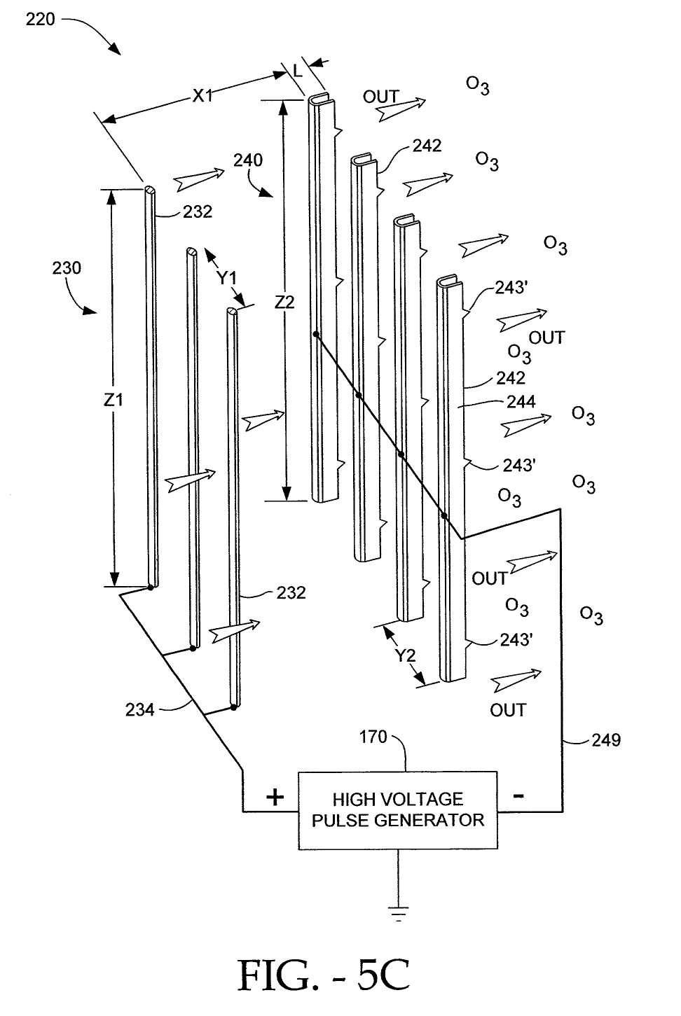

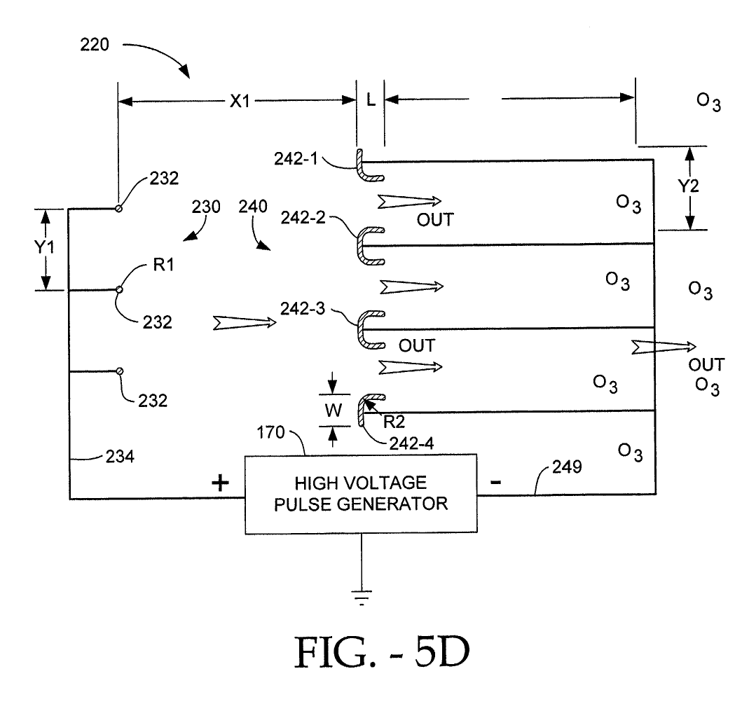

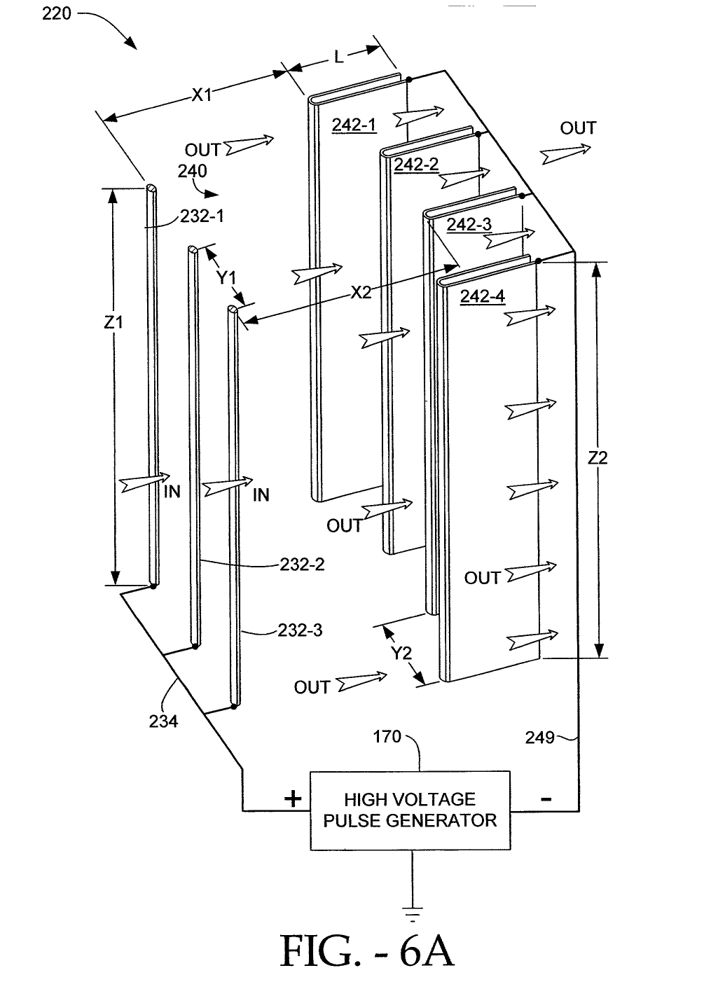

FIGS. 5A-5D

FIGS. 5A-5B illustrate various configurations of the electrode assembly 220. The electrode assembly 220 comprises a first array 230 of wire electrodes 232-1, 232-2, and 232-3 (collectively referred to as “electrodes 232”), and a second array 240 of generally “U”-shaped electrodes 242-1, 242-2, 242-3, and 242-4 (collectively referred to as “electrodes 242”). In preferred embodiments, the number N1 of electrodes comprising the first array 230 will preferably differ by one relative to the number N2 of electrodes comprising the second array 240. In many of the embodiments shown, N2>N1. However, additional first electrodes 232 could be added (e.g., electrodes 232-4, 232-5, etc.) such that N1>N2.

Electrodes 232 are preferably lengths of tungsten wire, whereas the hollow elongated “U”-shaped electrodes 242 are formed from sheet metal, preferably stainless steel, although brass or other sheet metal could be used. The sheet metal is formed to define side regions 244 and a rounded nose region 246. While particulate matter (not shown) is present in the incoming (IN) air, the outflow (OUT) air is substantially devoid of particulate matter, which adheres to the preferably large surface area provided by the second electrodes 242. The output air may, or may not, contain ozone.

As best seen in FIG. 5B, the spaced-apart configuration between the arrays is preferably staggered such that each first array electrode 232 is substantially equidistant from each second array electrode 242. This symmetrical staggering has been found to be an especially efficient electrode placement. Preferably the staggering geometry is symmetrical in that adjacent electrodes 232 or adjacent electrodes 242 are spaced-apart a constant distance, Y1 and Y2 respectively with the electrodes 232 preferably centered between each electrode 242. However, a non-symmetrical configuration is within the spirit and scope of this invention.

In FIGS. 5A-5B, typical dimensions are as follows: diameter of electrodes 232 is about 0.08 mm, distances Y1 and Y2 are each about 16 mm, distance X1 is about 16 mm, distance L is about 20 mm, and electrode heights Z1 and Z2 are each about 1 m. The width W of electrodes 242 is preferably about 4 mm, and the thickness of the material from which electrodes 242 are formed is about 0.5 mm. Of course, other dimensions and shapes could be used. It is preferred that electrodes 232 be small in diameter to help establish a desired high voltage field. On the other hand, it is desired that electrodes 232, as well as electrodes 242, be sufficiently robust to withstand occasional cleaning.

FIG. 5B illustrates theoretical electric field lines that ions will travel along from a first electrode 232 to a second electrode 242. In this configuration, ions strike the second electrode 242-2 along two paths, as shown by directional flow paths B and C. Similarly, ions strike the second electrode 242-3 along two flow paths, as shown by directional flow paths D and E. The second electrodes 242-1 and 242-4 attract ions primarily only along a single path, as shown by directional flow paths A and F, respectively.

As shown in FIG. 5B, the directional flow of ions emitted from the first electrode 232 contact the nose area 246 of the second electrode 242. A higher amount of energy is generated at the nose 246 than the trailing sides 244 of each second electrode 242. Thus, the second electrodes 242-2, 242-3 generate upwards of about twice as much energy as the second electrodes 242-1, 242-4 since they receive ions from two flow paths instead of one. Accordingly, each second electrode will not have a similar electric field at the nose 246. In this embodiment, the second electrodes 242-2, 242-3 will have a similar strength, and be higher than the second electrodes 242-1, 242-4. Thus, the array of second electrodes 240 will have an unbalanced electrical field at each nose 246. As a result, the second electrodes 242-2, 242-3 may generate a higher amount of ozone than the second electrodes 242-1, 242-4.

Each electrode 232 in the first array 230 is coupled by a conductor 234 to a first (preferably positive) output port of high voltage pulse generator 170, and each electrode 242 in the second array 240 is coupled by a conductor 249 to a second (preferably negative) output port of generator 170. It is relatively unimportant where on the various electrodes electrical connection is made to conductors 234 or 249. By way of example only, FIG. 5B depicts conductor 249 making connection with some electrodes 242 internal to the nose end 246, while other electrodes 242 make electrical connection to conductor 249 elsewhere on the electrode. An electrical connection to the various electrodes 242 could also be made on the electrode external surface providing no substantial impairment of the outflow airstream results; however, it has been formed to be preferable that the connection is made internally.

In this and the other embodiments to be described hereinafter, ionization appears to occur at the electrode 232 in the first electrode array 230, with ozone production occurring as a function of high voltage arcing. For example, increasing the peak-to-peak voltage amplitude and/or duty cycle of the pulses from the high voltage pulse generator 170 can increase ozone content in the output flow of ionized air. If desired, user-control S2 can be used to somewhat vary ozone content by varying (in an appropriate manner) amplitude and/or duty cycle. Specific circuitry for achieving such control is known in the art and need not be described in detail herein.

Note the inclusion in FIGS. 5A-5B of at least one output controlling electrode 243, preferably electrically coupled to the same potential as the second array electrodes 242. Electrode 243 preferably defines a pointed shape in side profile, e.g., a triangle. The sharp point on electrodes 243 causes the generation of substantial negative ions (since the electrode is coupled to relatively negative high potential). These negative ions neutralize excess positive ions otherwise present in the output airflow, such that the “OUT” flow has a net negative charge. Electrodes 243 preferably are stainless steel, copper, or other conductor, and are perhaps 20 mm high and about 12 mm wide at the base.

In FIG. 5C and the figures to follow, the particulate matter is omitted for ease of illustration. However, from what was shown in FIGS. 5A-5B, particulate matter will be present in the incoming air, and will be substantially absent from the outgoing air. As has been described, particulate matter 60 typically will be electrostatically precipitated upon the surface area of electrodes 242.

As discussed above and as depicted by FIG. 5C, it is relatively unimportant where on an electrode array electrical connection is made. Thus, first array electrodes 232 are shown electrically connected together at their bottom regions by conductor 234, whereas second array electrodes 242 are shown electrically connected together in their middle regions by the conductor 249. Both arrays maybe connected together in more than one region, e.g., at the top and at the bottom. It is preferred that the wire or strips or other inter-connecting mechanisms be at the top, bottom, or periphery of the second array electrodes 242, so as to minimize obstructing stream air movement through the housing 210.

It is noted that the embodiments of FIGS. 5C and 5D depict somewhat truncated versions of the second electrodes 242. Whereas dimension L in the embodiment of FIGS. 5A and 5B was about 20 mm, in FIGS. 5C and 5D, L has been shortened to about 8 mm. Other dimensions in FIG. 5C preferably are similar to those stated for FIGS. 5A and 5B. It will be appreciated that the configuration of second electrode array 240 in FIG. 5C can be more robust than the configuration of FIGS. 5A and 5B, by virtue of the shorter trailing edge geometry. As noted earlier, a symmetrical staggered geometry for the first and second electrode arrays is preferred for the configuration of FIG. 5C.

In the embodiment of FIG. 5D, the outermost second electrodes, denoted 242-1 and 242-4, have substantially no outermost trailing edges. Dimension L in FIG. 5D is preferably about 3 mm, and other dimensions maybe as stated for the configuration of FIGS. 5A and 5B. Again, the ratio of the radius or surface areas between the first electrode 232 and the second electrodes 242 for the embodiment of FIG. 5D preferably exceeds about 20:1.

Electrode Assembly with Recessed/Non-Equidistant Second Electrodes

Having described various aspects of the invention in general, preferred embodiments of electrode assembly 220 will now be described.

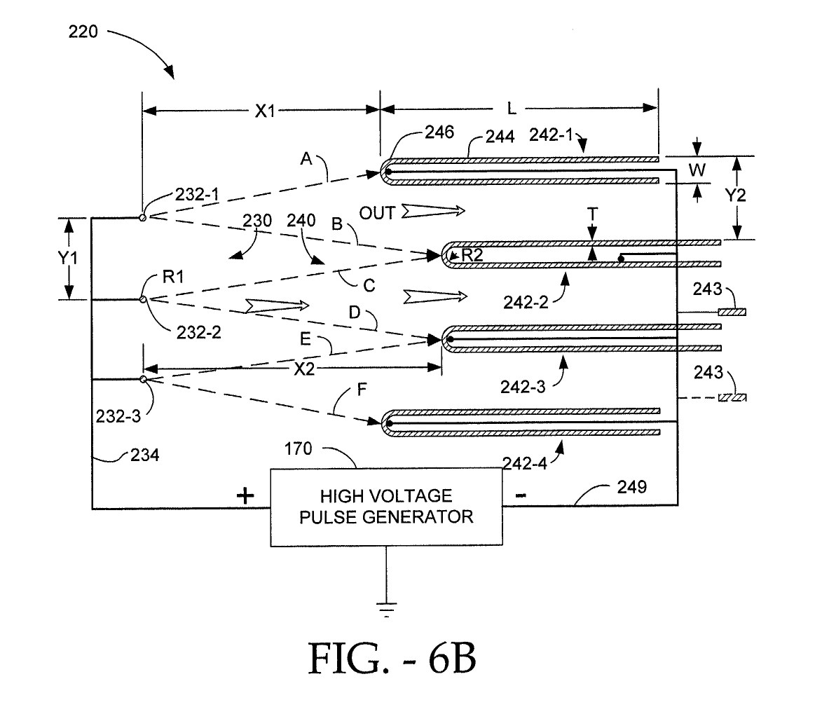

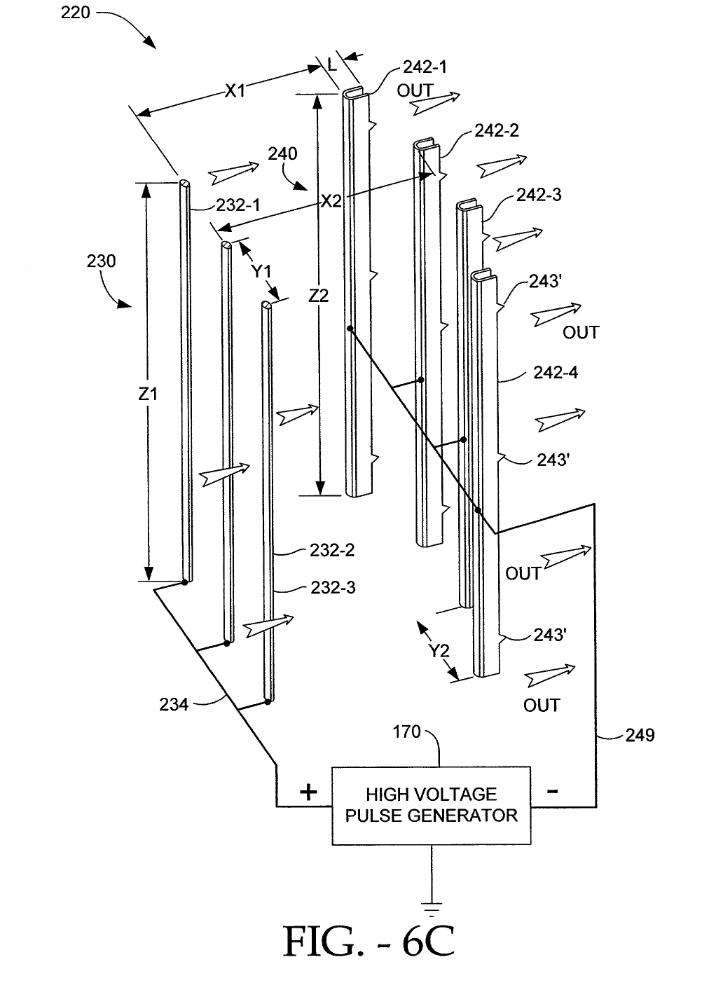

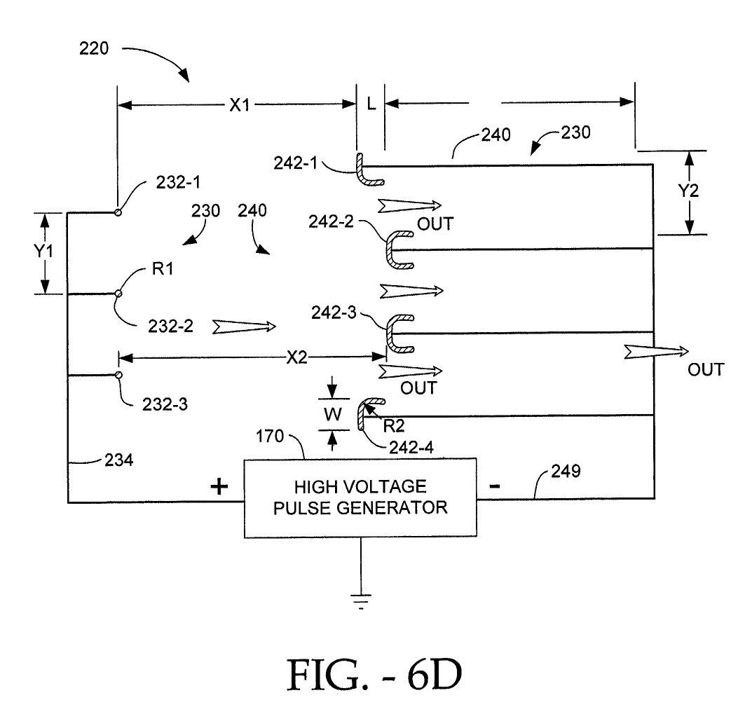

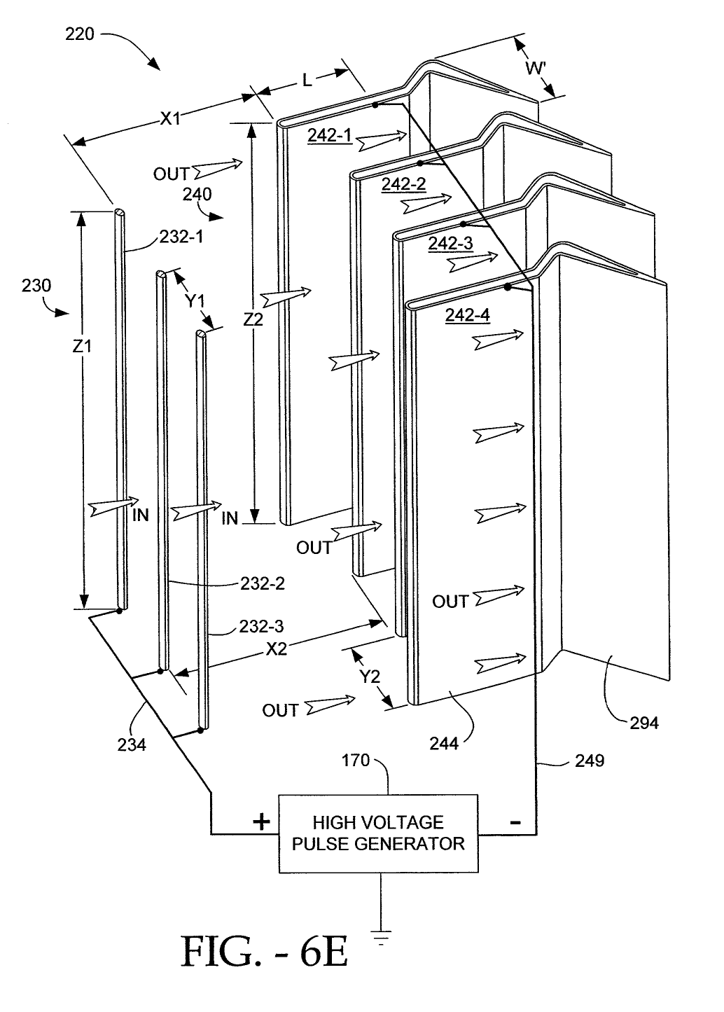

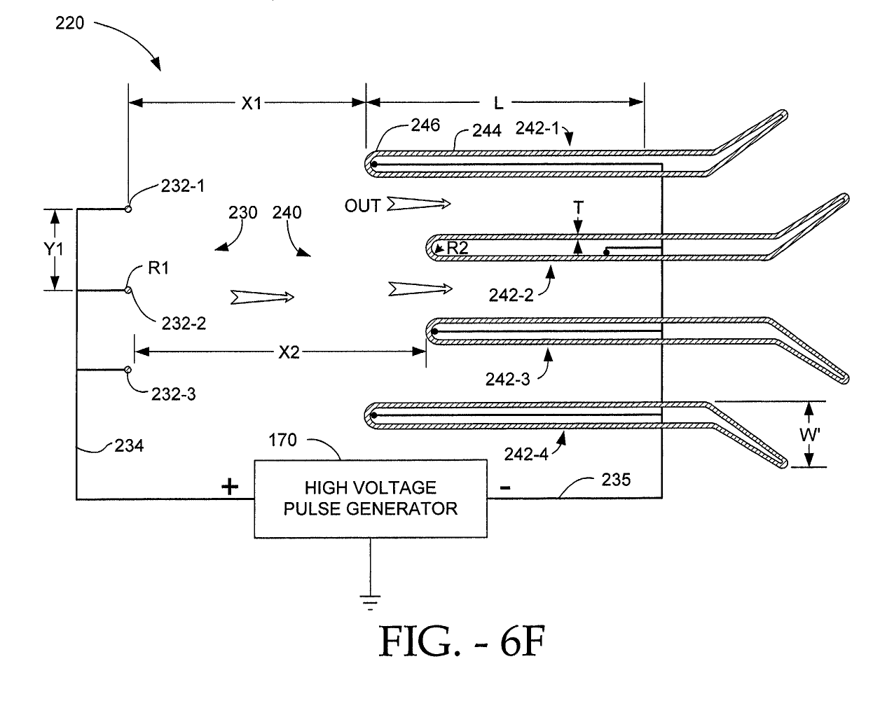

FIGS. 6A-6F

FIGS. 6A-6B illustrate an electrode assembly 220 including a first array 230 of wire-shaped electrodes 232-1, 232-2, and 232-3 (collectively referred to as “electrodes 232”), and a second array 240 of generally “U”-shaped electrodes 242-1, 242-2, 242-3, and 242-4 (collectively referred to as “electrodes 242”). In this configuration, the second electrodes 242-2, 242-3 are located further “downstream” than second electrodes 242-1, 242-4. Thus the electrodes positioned in the middle of the array are removed further downstream than the electrode and the outer edges of the array. Preferably, the second electrodes 242-2, 242-3 are located the same distance away from the first array 230, as shown by the distance X2. For example, the second electrodes 242-1, 242-4 are located a distance X1 downstream from the first electrodes 232, while the second electrodes 242-2, 242-3 are located a distance X2 downstream from the first electrodes 232. By way of example only, X2 is preferably 4 mm to 6 mm longer than X1. The distance X2 can also be 2 mm to 12 mm larger than X1. The distance X2 is preferably greater than X1 so that the strength of the electric field generated at the nose 246 of each second electrode 242 is substantially similar. Accordingly, this configuration will produce lower amounts of ozone than the embodiment shown in FIGS. 5A-5B. It is within the spirit and scope of the invention for X2 to be longer or shorter.

FIG. 6B illustrates theoretical ion directional flow paths A, B, C, D, E, and F. Each ion flow path A-F generally represents the path ions travel from a first electrode 232 to a second electrode 242. As previously mentioned, each second electrode 242 generates an electric field primarily at the nose 246, and is proportional to the quantity of ions that contact the electrode and the distance the ions travel before reaching the second electrode 242. Ions are emitted from the first electrodes 232. Ions lose the electrical charge as a function of time. Accordingly, an ion that travels a short distance, for example X1, will generate a stronger electrical field when it contacts the nose 246 than an ion that travels a distance X2 before contacting the nose 246.

The second electrode 242-2 primarily receives ions along flow paths B, C, while the second electrode 242-3 primarily receives ions along flow paths D, E. Normally, if all four second electrodes 242 were located the distance X1 downstream from the first electrodes 232, as shown in FIGS. 5A-5B, a stronger electrical field will occur at the nose 246 of second electrodes 242-2, 242-3 because these two second electrodes collect substantially more ions as electrodes 242-1, 242-4.

The distance X2 is preferably greater than X1 so that the strength of the electric field generated at the nose 246 of each second electrode 242 is substantially similar. The second electrodes 242-2, 242-3 still receive more ions than the second electrodes 242-1, 242-4. However, the additional distance each ion must travel, shown by X2-X1, will substantially offset the additional number of ions received. Accordingly, this configuration will produce lower amounts of ozone than the embodiment shown in FIGS. 5A-5B

FIG. 6C illustrates a preferred configuration of the embodiment shown in FIG. 5C. The second electrodes 242-2 and 242-3 are recessed downstream a distance X2 from the first array 230, which the second electrodes 242-1 and 242-4 remain a distance X1 downstream of the first array of electrodes 230. Similar to the embodiment shown in FIGS. 5A-5B, the second electrode 242-2 and 242-3 receive substantially more ions than the second electrodes 242-1 or 242-2. However, the strength of the electric field generated at the nose 246 of each second electrode 242 is preferably similar because of the additional distance each ion must travel to reach the recessed electrodes 242-2 and 242-3.

FIG. 6D illustrates a preferred configuration of the embodiment shown in FIG. 5D. Again, the second electrodes 242-2 and 242-3 are recessed downstream a distance X2 from the first array 230, which the second electrodes 242-1 and 242-4 remain a distance X1 downstream of the first array of electrodes 230. Similar to the embodiment shown in FIGS. 5A-5B, the second electrode 242-2 and 242-3 receive substantially more ions than the second electrodes 242-1 or 242-2. However, the strength of the electric field generated at the nose 246 of each second electrode 242 is preferably similar because of the additional distance each ion must travel to reach the recessed electrodes 242-2 and 242-3.

FIGS. 6E-6F illustrate that the second electrodes 242 may have angled or corrugated extensions 294. Preferably, the tail 294 is a non-linear configuration, having an effective width W′ greater than the width W (see FIG. 5B) of the second electrode 242. In FIG. 6E the trailing downstream portion is provided at an angle to the leading, upstream or nose portion. Thus, the extension 294 provides a wider structure than the nose 246 of the second electrode 242. The extensions 294 enhance the particle capture efficiency of the electrode assembly 220.

In general, larger airborne particles (e.g., one micron and larger) tend to have their own significant forward momentum in the air stream. A “U”-shaped second electrode 242 without an angled blade extension 294, as shown in FIG. 5A, might allow a larger particle to pass through the electrode assembly 220 uncaptured. The momentum of the particle may prevent it from contacting the trailing edges of the second electrode 242. The increased width W′ of the angled extension 246 is intended to capture the larger particles. For example, if the larger particle passes by the trailing side 244 of the second electrode 242 uncaptured, but the particle is within W′ of the trailing sides 244, the particle will be captured by the extension 294. It is within the spirit and scope of the invention for the extension 246 to comprise other non-linear shapes and configurations such as, but not limited to, a “U”-shape, an “L”-shape, a Z-shape, a shape with a first upstream portion and a second down stream portion provided at an angle to the upstream portion, and a shape with a tail section that is wider in the stream of air flow than the upstream, leading or nose portion. Tail sections 294 can be directed in the same direction and be parallel as depicted, or the tail sections can be configured to diverge from each other in order to form a “V” or a “Y” configuration adjacent to the outlet vent. Thus the upper tail sections 294 as shown in FIG. 6E are made to point upwardly on the page, with the lower two tail sections 294 remaining pointing downwardly on the page.

Electrode Assembly with Recessed/Non-Equidistant Second Electrodes and an Upstream Focus Electrode

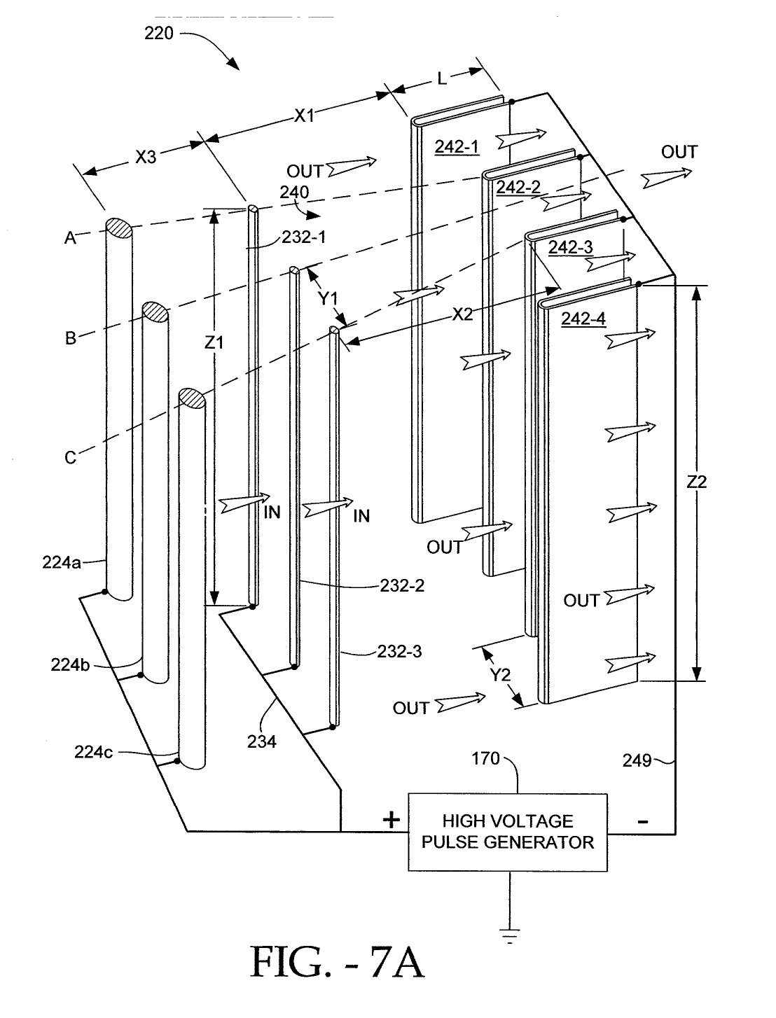

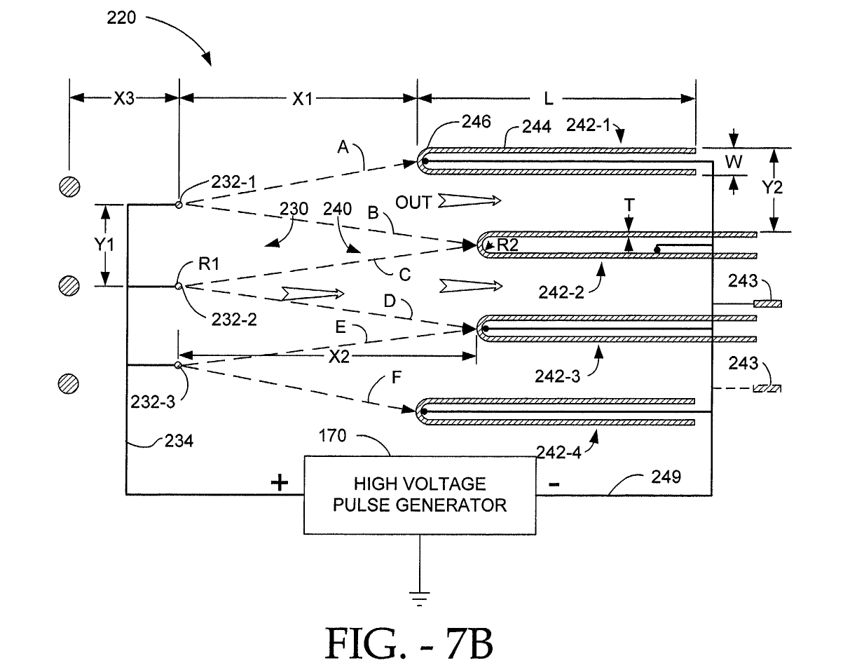

FIGS. 7A-7B

The embodiments illustrated in FIGS. 7A-7B are somewhat similar to the previously described embodiments in FIGS. 6A-6B. The electrode assembly 220 includes a first array of electrodes 230 and a second array of electrodes 240. Again, for this and the other embodiments, the term “array of electrodes” may refer to a single electrode or a plurality of electrodes. Preferably, the number of electrodes 232 in the first array of electrodes 230 will differ by one relative to the number of electrodes 242 in the second array of electrodes 240. The distances L, X1, Y1, Y2, Z1 and Z2 for this embodiment are similar to those previously described in FIG. 5A.

As shown in FIG. 7A, the electrode assembly 220 preferably adds a third, or leading, or focus, or directional electrode 224a, 224b, 224c (generally referred to as “electrode 224”) upstream of each first electrode 232-1, 232-2, 232-3. The focus electrode 224 produces an enhanced airflow velocity exiting the devices 100. In general, the third focus electrode 224 directs the airflow, and ions generated by the first electrode 232, towards the second electrodes 242. Each third focus electrode 224 is a distance X3 upstream from at least one of the first electrodes 232. The distance X3 is preferably 5-6 mm, or four to five diameters of the focus electrode 224. However, the third focus electrode 224 can be further from or closer to the first electrode 232.

The third focus electrode 224 illustrated in FIG. 7A is a rod-shaped electrode. The third focus electrode 224 can also comprise other shapes that preferably do not contain any sharp edges. The third focus electrode 224 is preferably manufactured from material that will not erode or oxidize, such as stainless steel. The diameter of the third focus electrode 224, in a preferred embodiment, is at least fifteen times greater than the diameter of the first electrode 232. The diameter of the third focus electrode 224 can be larger or smaller. The diameter of the third focus electrode 224 is preferably large enough so that third focus electrode 224 does not function as an ion emitting surface when electrically connected with the first electrode 232. The maximum diameter of the third focus electrode 224 is somewhat constrained. As the diameter increases, the third focus electrode 224 will begin to noticeably impair the airflow rate of the unit 100. Therefore, the diameter of the third electrode 224 is balanced between the need to form a non-ion emitting surface and airflow properties of the unit 100.

In a preferred embodiment, each third focus electrodes 224a, 224b, 224c are electrically connected with the first array 230 and the high voltage generator 170 by the conductor 234. As shown in FIG. 7A, the third focus electrodes 224 are electrically connected to the same positive outlet of the high voltage generator 170 as the first array 230. Accordingly, the first electrode 232 and the third focus electrode 224 generate a positive electrical field. Since the electrical fields generated by the third focus electrode 224 and the first electrode 232 are both positive, the positive field generated by the third focus electrode 224 can push, or repel, or direct, the positive field generated by the first electrode 232 towards the second array 240. For example, the positive field generated by the third focus electrode 224a will push, or repel, or direct, the positive field generated by the first electrode 232-1 towards the second array 240. In general, the third focus electrode 224 shapes the electrical field generated by each electrode 232 in the first array 230. This shaping effect is believed to decrease the amount of ozone generated by the electrode assembly 220 and increases the airflow of the unit 100.

The particles within the airflow are positively charged by the ions generated by the first electrode 232. As previously mentioned, the positively charged particles are collected by the negatively charged second electrodes 242. The third focus electrode 224 also directs the airflow towards the second electrodes 242 by guiding the charged particles towards the trailing edges 244 of each second electrode 242. It is believed that the airflow will travel around the third focus electrode 224, partially focusing the airflow towards the trailing edges 244, improving the collection rate of the electrode assembly 220.

The third focus electrode 224 maybe located at various positions upstream of each first electrode 232. Byway of example only, a third focus electrode 224b is located directly upstream of the first electrode 232-2 so that the center of the third focus electrode 224b is in-line and symmetrically aligned with the first electrode 232-2, as shown by extension line B. Extension line B is located midway between the second electrode 242-2 and the second electrode 242-3. Alternatively, a third focus electrode 224 can also be located at an angle relative to the first electrode 232. For example, a third focus electrode 224a can be located upstream of the first electrode 232-1 along a line extending from the middle of the nose 246 of the second electrode 242-2 through the center of the first electrode 232-1, as shown by extension line A. The third focus electrode 224a is in-line and symmetrically aligned with the first electrode 232-1 along extension line A. Similarly, the third electrode 224c is located upstream to the first electrode 232-3 along a line extending from the middle of the nose 246 of the second electrode 242-3 through the first electrode 232-3, as shown by extension line C. The third focus electrode 224c is in-line and symmetrically aligned with the first electrode 232-3 along extension line C. It is within the scope of the present invention for the electrode assembly 220 to include third focus electrodes 224 that are both directly upstream and at an angle to the first electrodes 232, as depicted in FIG. 7A.

Again, as with the prior embodiments, the innermost second electrodes 242-2 and 242-3 are recessed back from the first array of electrodes 230, and receive the advantages previously disclosed.

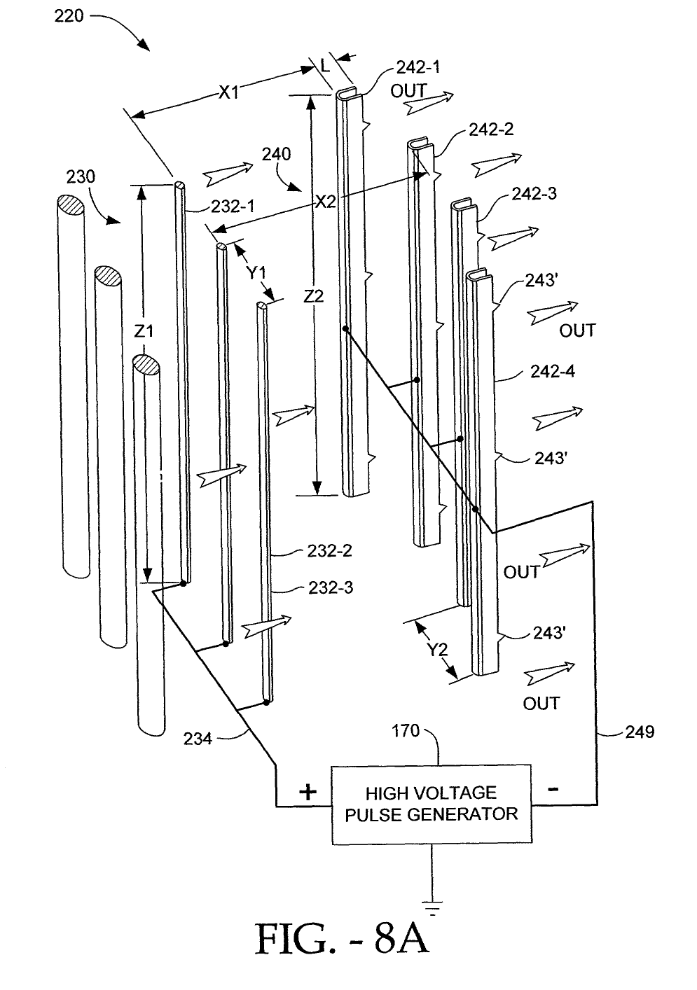

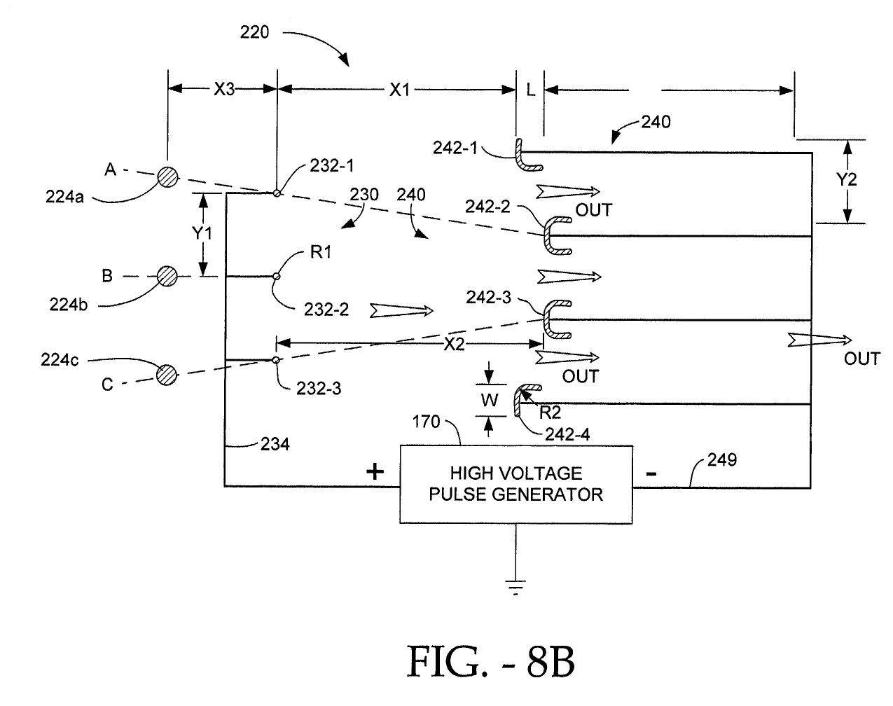

FIGS. 8A-8D

FIGS. 8A-8B illustrates an electrode assembly 220 including a first array of electrodes 230 having three wire-shaped first electrodes 232-1, 232-2, 232-3 (generally referred to as “electrode 232”) and a second array of electrodes 240 having four “U”-shaped second electrodes 242-1, 242-2, 242-3, 242-4 (generally referred to as “electrode 242”). Each electrode 232 is electrically connected to the high voltage generator 170 at the bottom region, whereas the second electrodes 242 are electrically connected to the high-voltage generator 170 in the middle to illustrate that the first and second electrodes 232, 242 can be electrically connected in a variety of locations.

The second electrode 242 in FIG. 8A is a similar version of the second electrode 242 shown in FIG. 5C. The distance L has been shortened to about 8 mm, while the other dimensions X1, Y1, Y2, Z1, Z2 are similar to those shown in FIG. 5A.

A third leading or focus electrode 224 is located upstream of each first electrode 232. The innermost third focus electrode 224b is located directly upstream of the first electrode 232-2, as shown by extension line B. Extension line B is located midway between the second electrodes 242-2, 242-3. The third focus electrodes 224a, 224c are at an angle with respect to the first electrodes 232-1, 232-3. For example, the third focus electrode 224a is upstream to the first electrode 232-1 along a line extending from the middle of the nose 246 of the second electrode 242-2 extending through the center of the first electrode 232-1, as shown by extension line A. The third electrode 224c is located upstream of the first electrode 232-3 along a line extending from the center of the nose 246 of the second electrode 242-3 through the center of the first electrode 232-3, as shown by extension line C. Accordingly and preferably the focus electrodes fan out relative to the first electrodes as an aid for directing the flow of ions and charged particles.

FIG. 8B illustrates third focus electrodes 224 added to the electrode assembly 220 shown in FIG. 5D. Preferably, a third focus electrode 224 is located upstream of each first electrode 232. For example, the third focus electrode 224b is in-line and symmetrically aligned with the first electrode 232-2, as shown by extension line B. Extension line B is located midway between the second electrodes 242-2, 242-3. The third focus electrode 224a is in-line and symmetrically aligned with the first electrode 232-1, as shown by extension line A. Similarly, the third electrode 224c is in-line and symmetrically aligned with the first electrode 232-3, as shown by extension line C. Extension lines A-C extend from the middle of the nose 246 of the “U”-shaped second electrodes 242-2, 242-3 through the first electrodes 232-1, 232-3, respectively. In a preferred embodiment, the third electrodes 224a, 224b, 224c with the high voltage generator 170 by the conductor 234. This embodiment can also include a pair of third focus electrodes 224 upstream of each first electrode 232.

FIG. 8C illustrates pairs of third focus electrodes 224 added to the electrode assembly 220 shown in FIG. 5D. Preferably, a pair of third focus electrodes 224 are located upstream of each first electrode 232. For example, the pair of third focus electrodes 224b and 224b′ are in-line and symmetrically aligned with the first electrode 232-2, as shown by extension line B. Extension line B is located midway between the second electrodes 242-2, 242-3. The pair of third focus electrodes 224a and 224a′ are in-line and symmetrically aligned with the first electrode 232-1, as shown by extension line A. Similarly, the pair of third electrodes 224c and 224c′ are in-line and symmetrically aligned with the first electrode 232-3, as shown by extension line C. Extension lines A-C extend from the middle of the nose 246 of the “U”-shaped second electrodes 242-2, 242-3 through the first electrodes 232-1, 232-3, respectively. In a preferred embodiment, only the third electrodes 224a, 224b, 224c are electrically connected to the high voltage generator 170 by the conductor 234, and the third electrodes 224a′ , 224b′ , and 224c′ have a floating potential.

In the embodiment of FIGS. 8A-8C, the middle second electrodes are recessed a distance X2 downstream for the reasons stated in the previous embodiments. Again, as with the prior embodiments, the innermost second electrodes 242-2 and 242-3 are recessed back from the first array of electrodes 230, and receive the advantages previously disclosed.

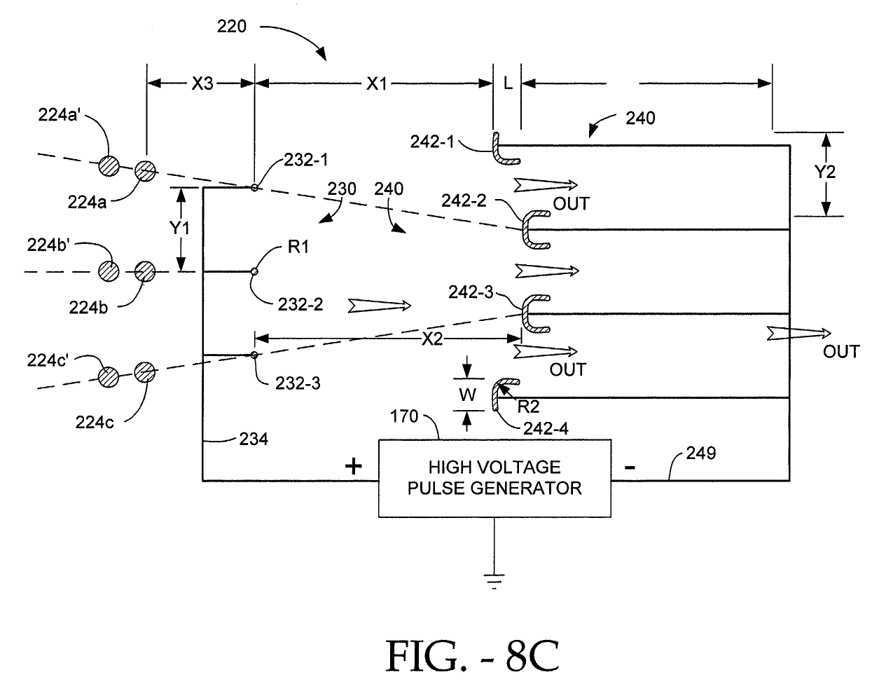

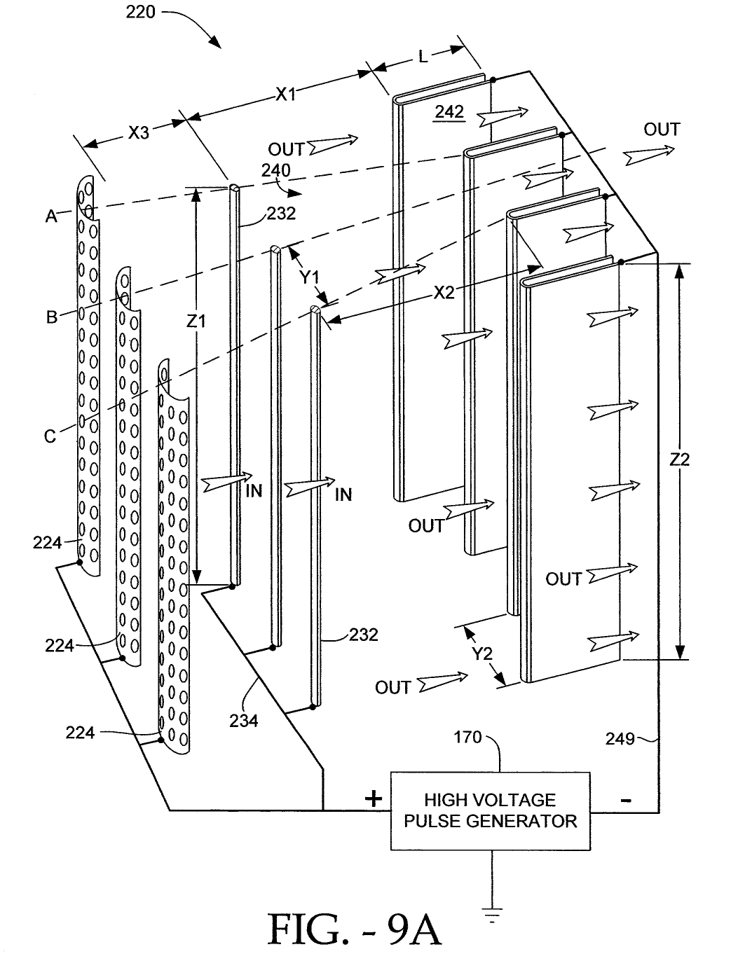

FIGS. 9A-9B

The previously described embodiments of the electrode assembly 220 disclose a rod- shaped third focus electrode 224 upstream of each first electrode 232. FIG. 9A illustrates an alternative configuration for the third focus electrode 224. By way of example only, the electrode assembly 220 may include a “U”-shaped or possibly “L”-shaped third focus electrode 224 upstream of each first electrode 232. Further the third focus electrode 224 can have other curved configurations such as, but not limited to, circular-shaped, elliptical-shaped, and other concave shapes facing the first electrode 232. In a preferred embodiment, the third focus electrode 224 has holes 225 extending through, forming a perforated surface to minimize the resistance of the third focus electrode 224 on the airflow rate.

In a preferred embodiment, the third focus electrode 224 is electrically connected to the high voltage generator 170 by conductor 234. The third focus electrode 224 in FIGS. 9A-9B is preferably not an ion emitting surface. Similar to previous embodiments, the third focus electrode 224 generates a positive electric field and pushes or repels the electric field generated by the first electrode 232 towards the second array 240.

FIG. 9A illustrates that a perforated “U”-shaped third focus electrode 224 can be incorporated into the electrode assembly 220 shown in FIG. 5A. Even though only two configurations of the electrode assembly 220 are shown with the perforated “U”-shaped, or parabolic shaped, third focus electrode 224, all the embodiments described in FIGS. 6A-13 may incorporate the perforated “U”-shaped, or parabolic shaped, third focus electrode 224. It is also within the scope of the invention to have multiple perforated “U”-shaped, or parabolic shaped, third focus electrodes 224 upstream of each first electrode 232. Further, in other embodiments, the “U”-shaped third focus electrode can be made of a screen or mesh.

FIG. 9B illustrates third focus electrodes 224 similar to those depicted in FIG. 9A, except that the third focus electrodes 224 are rotated by 180° to preset a convex surface facing to the first electrodes 232 in order to focus and direct the field of ions and airflow from the first electrode 232 toward the second electrode 242. These third focus electrodes 224 shown in FIGS. 9A-9B are located along extension lines A, B, C similar to previously described embodiments.

Again, as with the prior embodiments, the innermost second electrodes 242-2 and 242-3 are recessed back from the first array of electrodes 230, and receive the advantages previously disclosed.

Electrode Assemblies with Various Combinations of Focus Electrode, Trailing Electrodes and Second Electrodes with Protective Ends

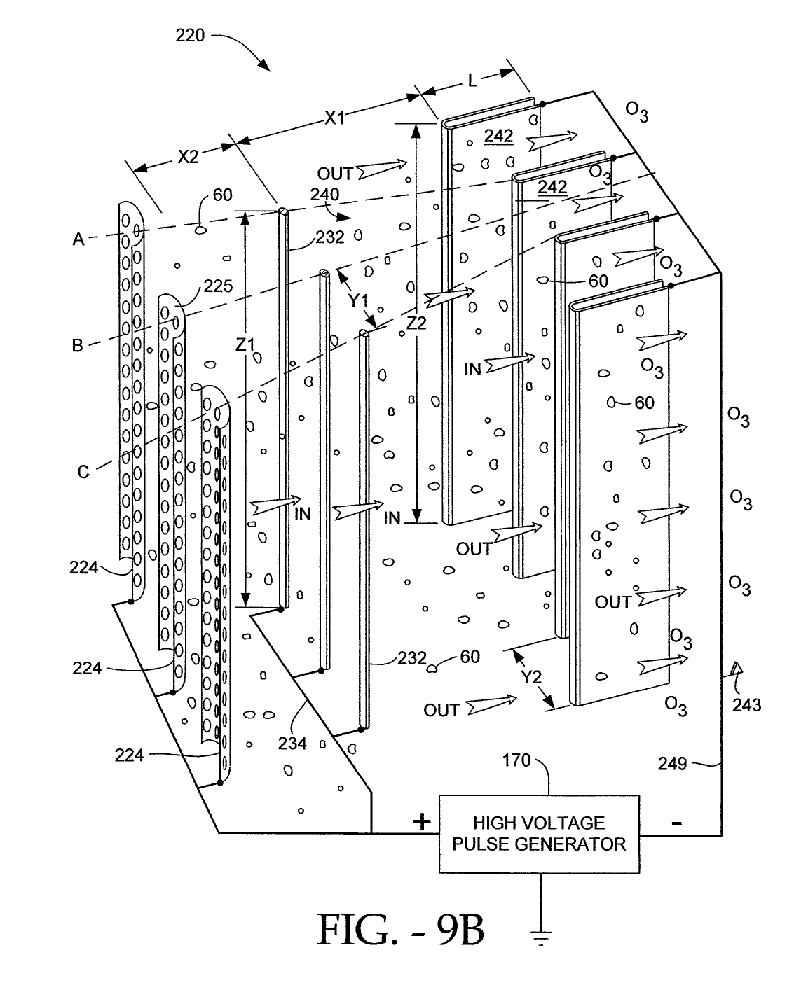

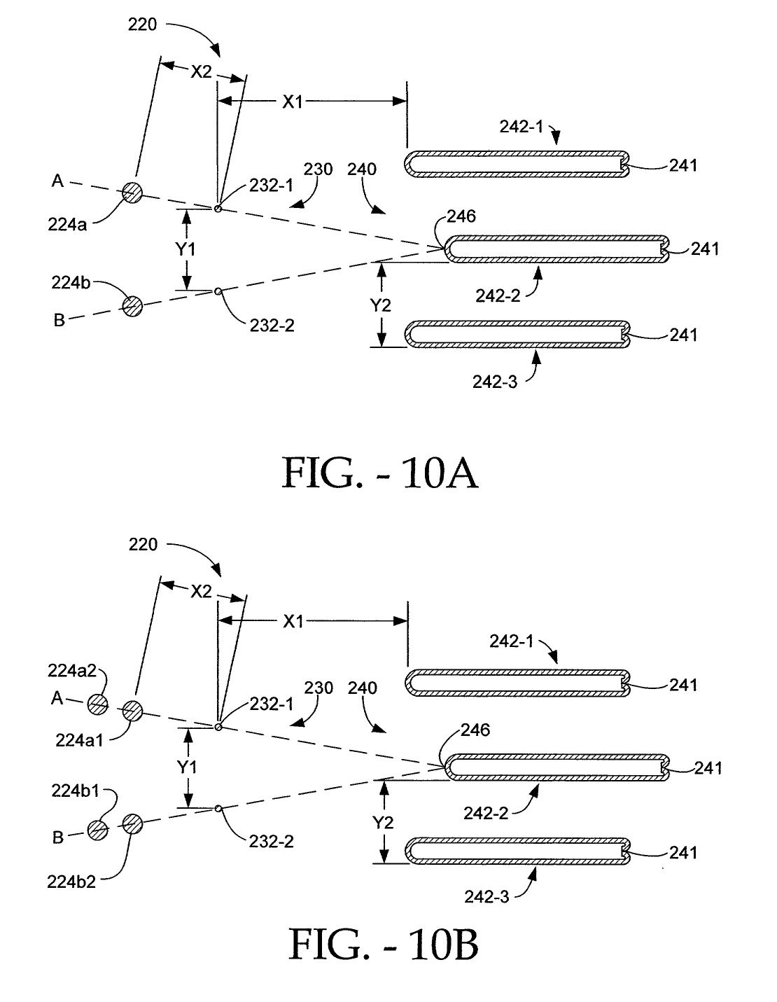

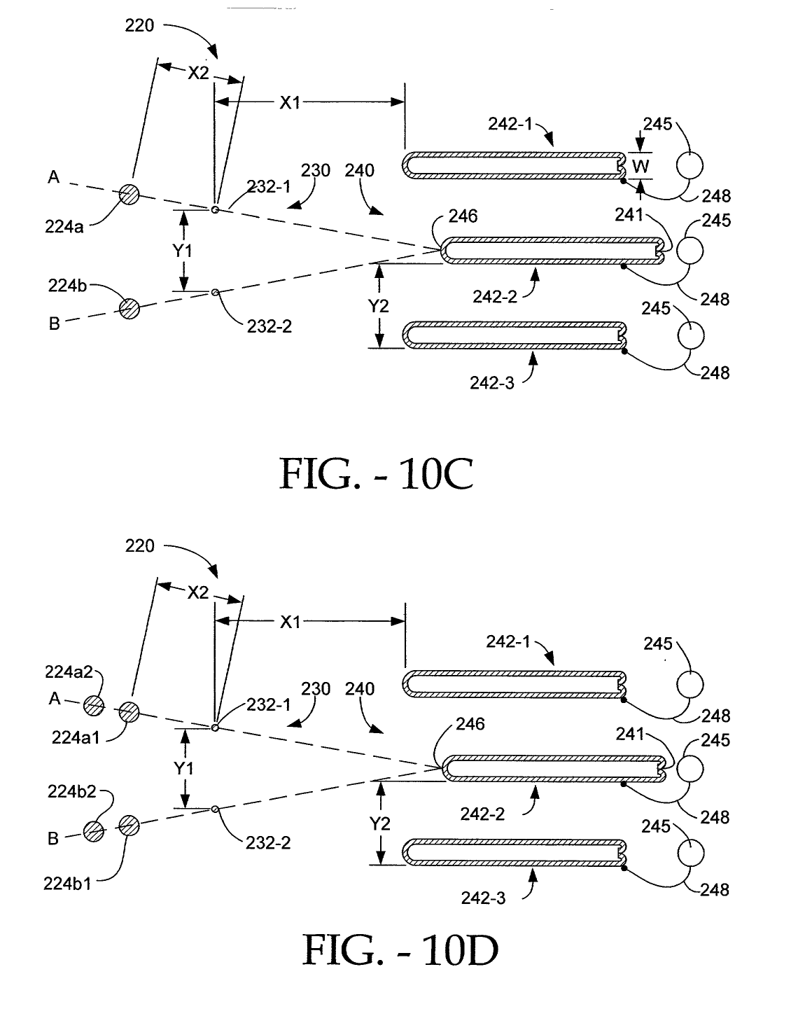

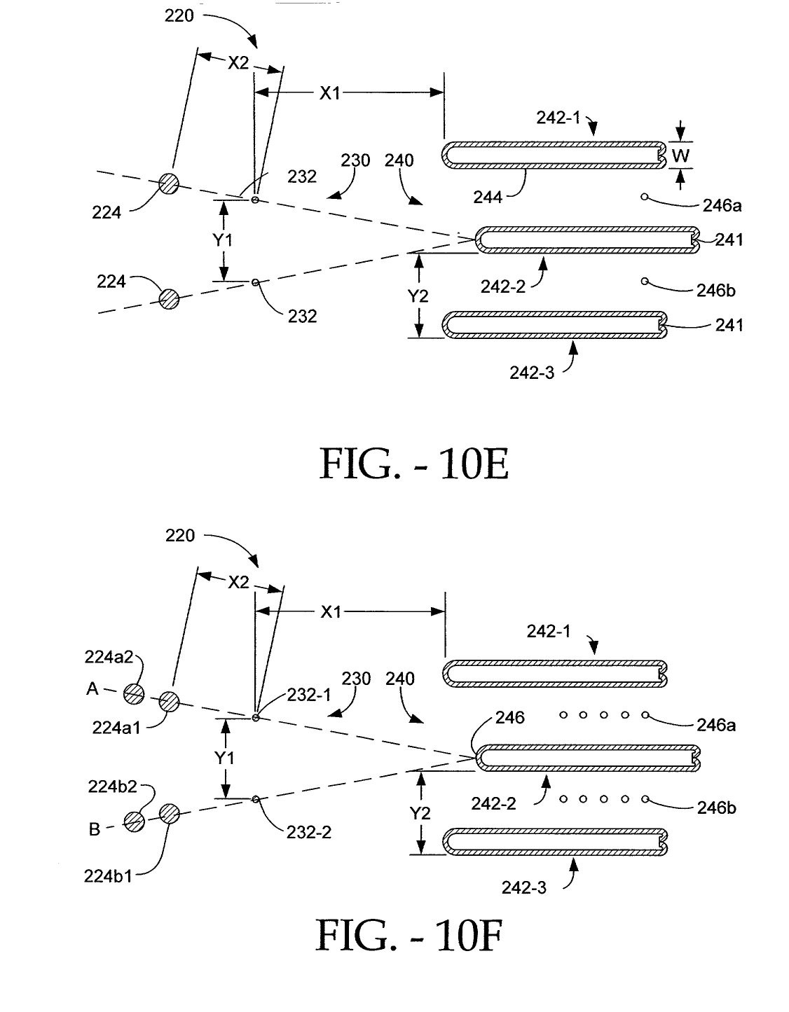

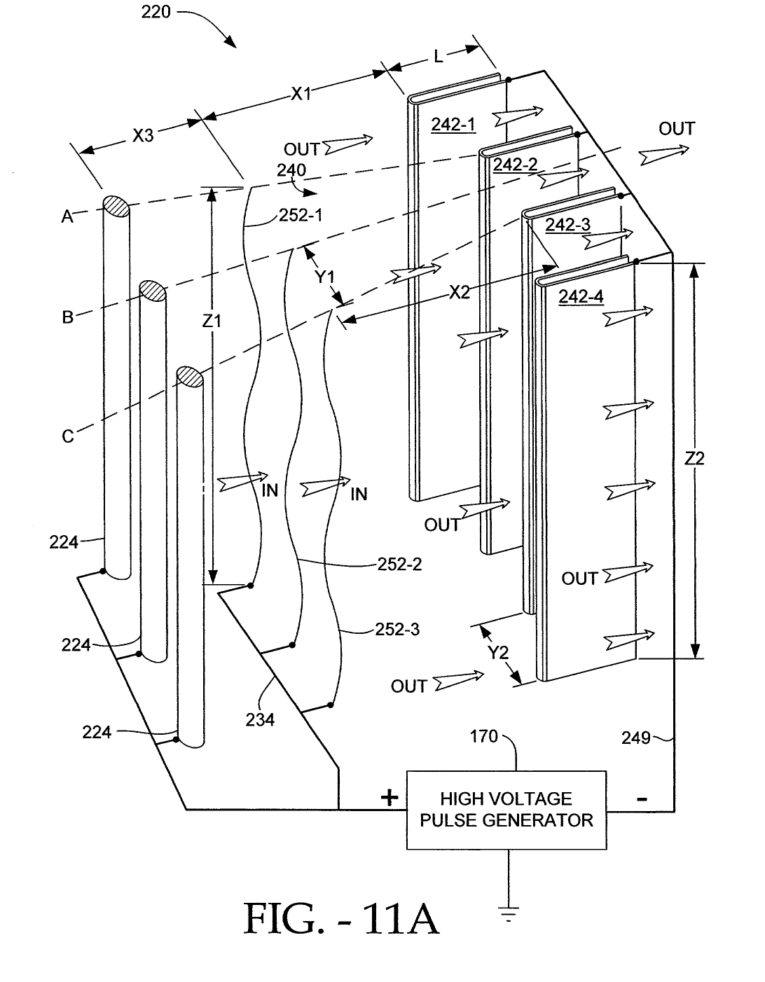

FIGS. 10A-10D

FIG. 10A illustrates an electrode assembly 220 that includes a first array of electrodes 230 having two wire-shaped electrodes 232-1, 232-2 (generally referred to as “electrode 232”) and a second array of electrodes 240 having three “U”-shaped electrodes 242-1, 242-2, 242-3 (generally referred to as “electrode 242”). This configuration is in contrast to, for example, the configurations of FIG. 8A, wherein there are three first emitter electrodes 232 and four second collector electrodes 242. Upstream from each first electrode 232, at a distance X2, is a third focus electrode 224. Each third focus electrode 224a, 224b is at an angle with respect to a first electrode 232. For example, the third focus electrode 224a is preferably along a line extending from the middle of the nose 246 of the second electrode 242-2 through the center of the first electrode 232-1, as shown by extension line A. The third focus electrode 224a is in-line and symmetrically aligned with the first electrode 232-1 along extension line A. Similarly, the third focus electrode 224b is located along a line extending from middle of the nose 246 of the second electrode 242-2 through the center of the first electrode 232-2, as shown by extension line B. The third focus electrode 224b is in-line and symmetrically aligned with the first electrode 232-2 along extension line B. As previously described, the diameter of each third focus electrode 224 is preferably at least fifteen times greater than the diameter of the first electrode 232. As shown in FIG. 10A, and similar to the embodiment shown in FIG. 5B, each second electrode preferably has a protective end 241. In a preferred embodiment, the third focus electrodes 224 are electrically connected to the high voltage generator 170 (not shown). It is within the spirit and scope of the invention to not electrically connect the third focus electrodes 224.

FIG. 10B illustrates that multiple third focus electrodes 224 maybe located upstream of each first emitter electrode 232. For example, the third focus electrode 224a2 is in-line and symmetrically aligned with the third focus electrode 224a1 along extension line A. Similarly, the third focus electrode 224b2 is in-line and symmetrically aligned with the third focus electrode 242b1 along extension line B. It is within the scope of the present invention to electrically connect all, or none of, the third focus electrodes 224 to the high-voltage generator 170. In a preferred embodiment, only the third focus electrodes 224a1, 224b1 are electrically connected to the high voltage generator 170, with the third focus electrodes 224a2, 224b2 having a floating potential.

FIG. 10C illustrates that the electrode assembly 220 shown in FIG. 10A may also include a trailing electrode 245 downstream of each second electrode 242. Each trailing electrode 245 is in-line with the second electrode so as not to interfere with airflow past the second electrode 242. Each trailing electrode 245 is preferably located a distance downstream of each second electrode 242 equal to at least three times the width W of the second electrode 242. Other distances are within the scope of the invention. It is within the scope of the present invention for the trailing electrode to by located at other distances downstream. The diameter of the trailing anode 245 is preferably no greater than the width W of the second electrode 242 to limit the interference of the airflow coming off the second electrode 242.

One aspect of the trailing electrode 245 is to direct the air trailing off the second electrode 242 and provide a more laminar flow of air exiting the outlet 260. Another aspect of the trailing electrode 245 is to neutralize the positive ions generated by the first array 230 and collect particles within the airflow. As shown in FIG. 10C, each trailing electrode 245 is electrically connected to a second electrode 242 by a conductor 248. Thus, the trailing electrode 245 is negatively charged, and serves as a collecting surface, similar to the second electrode 242, attracts the positively charged particles in the airflow. As previously described, the electrically connected trailing electrode 245 also emits negative ions to neutralize the positive ions emitted by the first electrodes 232.

FIG. 10D illustrates that a pair of third focus electrodes 224 maybe located upstream of each first electrode 232. For example, the third focus electrode 224a2 is upstream of the third focus electrode 224a1 so that the third focus electrodes 224a1, 224a2 are in-line and symmetrically aligned with each other along extension line A. Similarly, the third focus electrode 224b2 is in line and symmetrically aligned with the third focus electrode 224b1 along extension line B. As previously described, preferably only the third focus electrodes 224a1, 224b1 are electrically connected to the high voltage generator 170, while the third focus electrodes 224a2, 224b2 have a floating potential. It is within the spirit and scope of the present invention to electrically connect all, or none, of the third focus electrodes to the high voltage generator 170.

Again, as with the prior embodiments, the innermost second electrode 242-2 is recessed back from the first array of electrodes 230, and receives the advantages previously disclosed.

Electrode Assemblies with Second Collector Electrodes Having Interstitial Electrodes

FIG. 10E illustrates another embodiment of the electrode assembly 220 with an interstitial electrode 246. In this embodiment, the interstitial electrode 246 is located midway between the second electrodes 242. For example, the interstitial electrode 246a is located midway between the second electrodes 242-1, 242-2, while the interstitial electrode 246b is located midway between second electrodes 242-2, 242-3. Preferably, the interstitial electrode 246a, 246b are electrically connected to the first electrodes 232, and generate an electrical field with the same positive or negative charge as the first electrodes 232. The interstitial electrode 246 and the first electrode 232 then have the same polarity. Accordingly, particles traveling toward the interstitial electrode 246 will be repelled by the interstitial electrode 246 towards the trailing sides 244 of the second electrodes 242. Alternatively, the interstitial electrodes can have a floating potential or be grounded.

It is to be understood that interstitial electrodes 246a, 246b may also be closer to one second collector electrode than to the other. Also, the interstitial electrodes 246a, 246b are preferably located substantially near or at the protective end 241 or ends of the trailing sides 244, as depicted in FIG. 10E. Still further the interstitial electrode can be substantially located along a line between the two trailing portions or ends of the second electrodes. These rear positions are preferred as the interstitial electrodes can cause the positively charged particle to deflect towards the trailing sides 244 along the entire length of the negatively charged second collector electrode 242, in order for the second collector electrode 242 to collect more particles from the airflow.

Still further, the interstitial electrodes 246a, 246b can be located upstream along the trailing side 244 of the second collector electrodes 244. However, the closer the interstitial electrodes 246a, 246b get to the nose 246 of the second electrode 242, generally the less effective interstitial electrodes 246a, 246b are in urging positively charged particles toward the entire length the second electrodes 242. Preferably, the interstitial electrodes 246a, 246b are wire-shaped and smaller or substantially smaller in diameter than the width “W′” of the second collector electrodes 242. For example, the interstitial electrodes can have a diameter of, the same as, or on the order, of the diameter of the first electrodes. For example, the interstitial electrodes can have a diameter of one-sixteenth of an inch. Also, the diameter of the interstitial electrodes 246a, 246b is substantially less than the distance between second collector electrodes, as indicated by Y2. Further the interstitial electrode can have a length or diameter in the downstream direction that is substantially less than the length of the second electrode in the downstream direction. The reason for this size of the interstitial electrodes 246a, 246b is so that the interstitial electrodes 246a, 246b have a minimal effect on the airflow rate exiting the device 200.

FIG. 10F illustrates that the electrode assembly 220 in FIG. 10E can include a pair of third electrodes 224 upstream of each first electrode 232. As previously described, the pair of third electrodes 224 are preferably in-line and symmetrically aligned with each other. For example, the third electrode 224a2 is in-line and symmetrically aligned with the third electrode 224a1 along extension line A. Extension line A preferably extends from the middle of the nose 246 of the second electrode 242-2 through the center of the first electrode 232-1. As previously disclosed, in a preferred embodiment, only the third electrodes 224a1, 224b1 are electrically connected to the high voltage generator 170. In FIG. 10F, a plurality of interstitial electrodes 246a and 246b are located between the second electrodes 242. Preferably these interstitial electrodes are in-line and have a potential gradient with an increasing voltage potential on each successive interstitial electrode in the downstream direction in order to urge particles toward the second electrode. In this situation the voltage on the interstitial electrodes would have the same sign as the voltage on the first electrodes 232.

Again, as with the prior embodiments, the innermost second electrode 242-2 is recessed back from the first array of electrodes 230, and receive the advantages previously disclosed.

Electrode Assembly With an Enhanced First Emitter Electrodes

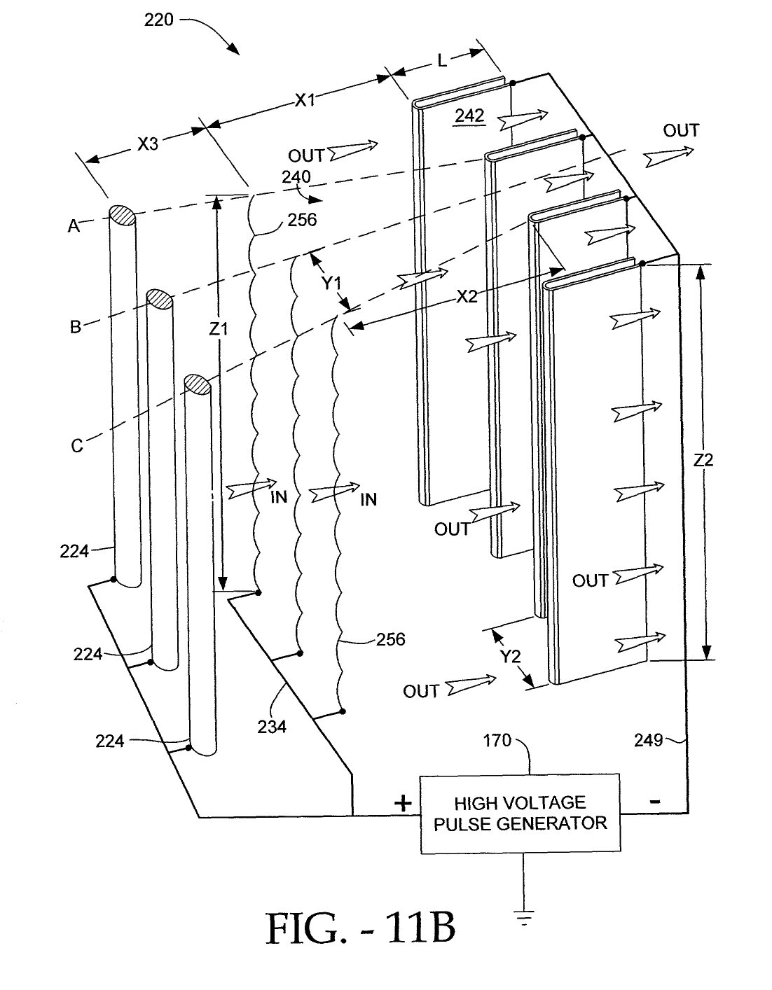

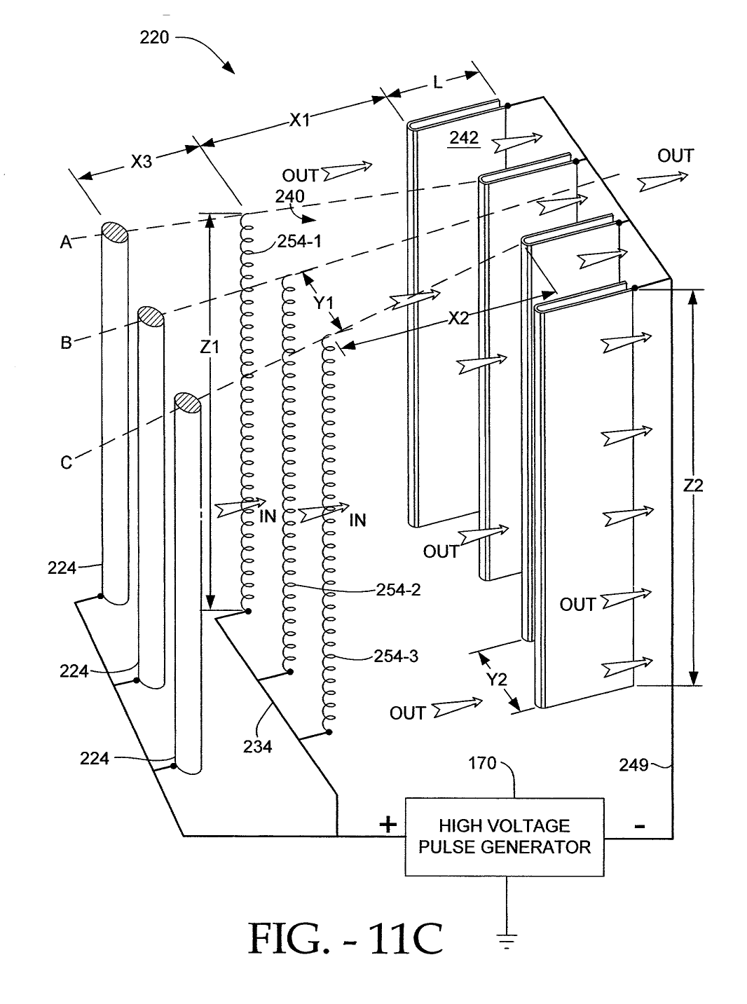

FIGS. 11A-11C

The previously described embodiments of the electrode assembly 220 include a first array of electrodes 230 having at least one wire-shaped electrode 232. It is within the scope of the present invention for the first array of electrodes 230 to contain electrodes consisting of other shapes and configurations.

FIG. 11A illustrates that the first array of electrodes 230 may include curved wire-shaped electrodes 252. The curved wire-shaped electrode 252 is an ion emitting surface and generates an electric field similar to the previously described wire-shaped electrodes 232. Also similar to previous embodiments, each second electrode 242 is “downstream,” and each third focus electrode 224 is “upstream,” to the curved wire-shaped electrodes 252. The electrical properties and characteristics of the second electrode 242 and the third focus electrode 224 are similar to the previously described embodiment shown in FIG. 6A. It is to be understood that an alternative embodiment of FIG. 11A can exclude the focus electrodes and be within the spirit and scope of the invention.

As shown in FIG. 11A, positive ions are generated and emitted by the first electrode 252. In general, the quantity of negative ions generated and emitted by the first electrode is proportional to the surface area of the first electrode. The height Z1 of the first electrode 252 is equal to the height Z1 of the previously disclosed wire-shaped electrode 232. However, the total length of the electrode 252 is greater than the total length of the electrode 232. By way of example only, and in a preferred embodiment, if the electrode 252 was straightened out the curved or slack wire electrode 252 is 15-30% longer than a rod or wire-shaped electrode 232. The electrode 252 is allowed to be slack to achieve the shorter height Z1 . When a wire is held slack, the wire may form a curved shape similar to the first electrode 252 shown in FIG. 11 A. The greater total length of the electrode 252 translates to a larger surface area than the wire-shaped electrode 232. Thus, the electrode 252 will generate and emit more ions than the electrode 232. Ions emitted by the first electrode array attach to the particulate matter within the airflow. The charged particulate matter is attracted to, and collected by, the oppositely charged second collector electrodes 242. Since the electrodes 252 generate and emit more ions than the previously described electrodes 232, more particulate matter will be removed from the airflow.

FIG. 11B illustrates that the first array of electrodes 230 may include flat coil wire-shaped electrodes 254. Each flat coil wire-shaped electrode 254 also has a larger surface area than the previously disclosed wire-shaped electrode 232. Byway of example only, if the electrode 254 was straightened out, the electrode 254 will have a total length that is preferably 10% longer than the electrode 232. Since the height of the electrode 254 remains at Z1, the electrode 254 has a “kinked” configuration as shown in FIG. 11 B. This greater length translates to a larger surface area of the electrode 254 than the surface area of the electrode 232. Accordingly, the electrode 254 will generate and emit a greater number of ions than electrode 232. It is to be understood that an alternative embodiment of FIG. 11B can exclude the focus electrodes and be within the spirit and scope of the invention.

FIG. 11C illustrates that the first array of electrodes 230 may also include coiled wire-shaped electrodes 256. Again, the height Z1 of the electrodes 256 is similar to the height Z1 of the previously described electrodes 232. However, the total length of the electrodes 256 is greater than the total length of the electrodes 232. In a preferred embodiment, if the coiled electrode 256 was straightened out the electrodes 256 will have a total length two to three times longer than the wire-shaped electrodes 232. Thus, the electrodes 256 have a larger surface area than the electrodes 232, and generate and emit more ions than the first electrodes 232. The diameter of the wire that is coiled to produce the electrode 256 is similar to the diameter of the electrode 232. The diameter of the electrode 256 itself is preferably 1-3 mm, but can be smaller in accordance with the diameter of first emitter electrode 232. The diameter of the electrode 256 shall remain small enough so that the electrode 256 has a high emissivity and is an ion emitting surface. It is to be understood that an alternative embodiment of FIG. 11C can exclude the focus electrodes and be within the spirit and scope of the invention.

The electrodes 252, 254 and 256 shown in FIGS. 11A-11C maybe incorporated into any of the electrode assembly 220 configurations previously disclosed in this application.

Again, as with the prior embodiments, the innermost second electrodes 242-2 and 242-3 are recessed back from the first array of electrodes 230, and receive the advantages previously disclosed.

The foregoing description of the preferred embodiments of the present invention has been provided for the purposes of illustration and description. It is not intended to be exhaustive or to limit the invention to the precise forms disclosed. Obviously, many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

Modifications and variations maybe made to the disclosed embodiments without departing from the subject and spirit of the invention as defined by the following claims.

1. An electro-kinetic air transporter-conditioner, comprising:
a housing having an inlet and an outlet;
a voltage generator; and
an electrode assembly electrically connected to said voltage generator, said electrode assembly creates an airflow from said inlet to said outlet when said voltage generator is energized, said electrode assembly including:
a first array of electrodes having at least two first electrodes; and
a second array of electrodes having at least three second electrodes, located downstream and staggered in relation to said first array, wherein one of said second electrodes in said second array is a greater distance downstream from said first array than the remaining of said second electrodes in said second array.

2. The electro-kinetic air transporter-conditioner of claim 1 wherein said one of said second electrodes is located between said remaining second electrode.

3. The electro-kinetic air transporter-conditioner of claim 1 wherein said one of said second electrode is aligned with a line that is mid-way between the first two electrodes.

4. The electro-kinetic air transporter-conditioner as recited in claim 1, wherein said first array of electrodes has at least one electrode that shares at least one characteristic from a group consisting of (i) a rod-shaped wire, (ii) a spiral coil, (iii) a curved wire, and (iv) a flat spiral wire.

5. The electro-kinetic air transporter-conditioner as recited in claim 1, wherein said second array of electrodes includes at least one electrode with a characteristic selected from a group consisting of(i) an elongated cylindrical tube,(ii) an electrode with a U-shaped cross-section, (iii) an electrode with an L-shaped cross-section, (iv) an electrode with a rod-shaped cross-section, and (v) an electrode with a front section and a tail section located at an angle to the front section.

6. The electro-kinetic air transporter-conditioner as recited in claim 1, wherein the air transporter-conditioner further includes a third focus electrode located upstream of said first array of electrodes.

7. The electro-kinetic air transporter-conditioner as recited in claim 1, wherein the air transporter-conditioner further includes a trailing electrode located downstream of said second array of electrodes.

8. An electro-kinetic air transporter-conditioner, comprising:
a housing having an inlet and an outlet;
a voltage generator; and
an electrode assembly electrically connected to said voltage generator, said electrode assembly creates an airflow from said inlet to said outlet when said voltage generator is energized, said electrode assembly includes:
a first array of electrodes, aligned to define a first plane; and
a second array of electrodes, including two outermost second electrodes, each having a nose, said nose of each said outermost second electrodes aligned to define a second plane parallel to said first plane, and an innermost second electrode recessed from said second plane so that the innermost second electrode is further downstream from said first array of electrodes than said outermost second electrodes.

9. The electro-kinetic air transporter-conditioner as recited in claim 8, wherein said first array of electrodes includes at least one electrode that shares at least one characteristic from a group consisting of (i) a rod-shaped wire, (ii) a spiral coil, (iii) a curved wire, and (iv) a flat spiral wire.

10. The electro-kinetic air transporter-conditioner as recited in claim 8, wherein said second array of electrodes includes at least one electrode with a characteristic selected from a group consisting of(i) an elongated cylindrical tube,(ii) an electrode with a U-shaped cross-section, (iii) an electrode with an L-shaped cross-section, (iv) an electrode with a rod-shaped cross-section, and (v) an electrode with a front section and a tail section located at an angle to the front section.

11. The electro-kinetic air transporter-conditioner as recited in claim 8, wherein the air transporter-conditioner further includes a third focus electrode located upstream of said first array of electrodes.

12. The electro-kinetic air transporter-conditioner as recited in claim 8, wherein the air transporter-conditioner further includes a trailing electrode located downstream of said second array of electrodes.

13. The electro-kinetic air transporter-conditioner as recited in claim 8, wherein said innermost electrode is 2-12 mm further downstream from said first array of electrodes than said outermost electrodes.

14. An electro-kinetic air transporter-conditioner, comprising:
a housing having an inlet and an outlet;
a voltage generator disposed within said housing;
an electrode assembly electrically connected to said voltage generator, said electrode assembly creates an airflow from said inlet to said outlet when said voltage generator is energized, said electrode assembly includes:
a first array of electrodes, including a plurality of first electrodes;
a second array of electrodes including a plurality of second electrodes, having at least one more second electrode than said first plurality of electrodes and staggered in relation to said first array, where in one or more of said second electrodes in said second array is located further from said first array than the other of said plurality of second electrodes.

15. An electro-kinetic air transporter-conditioner, comprising:
a housing having an inlet and an outlet;
a voltage generator disposed within said housing;
an electrode assembly, electrically connected to said voltage generator, said electrode assembly creates an airflow from said inlet to said outlet when said high voltage generator is energized, said electrode assembly includes:
a plurality of ion emitter electrodes; and
a plurality of ion collector electrodes staggered in relation to, and located downstream from, said ion emitter electrodes, one or more of said ion collector electrodes receives ions from principally two of said ion emitter electrodes and one or more of said ion collectors electrodes receives ions from principally one said ion emitter electrodes, said one or more ion collector electrodes that receives ions from principally two ion emitter electrodes being located further downstream from said ion emitter electrodes than said one or more ion collector electrode that receives ions from principally one ion emitter electrode.

16. The electro-kinetic air transporter-conditioner as recited in claim 15, wherein said ion emitting electrodes includes at least one electrode that shares at least one characteristic from a group consisting of(i) a rod-shaped wire, (ii) a spiral coil, (iii) a curved wire, and (iv) a flat spiral wire.

17. The electro-kinetic air transporter-conditioner as recited in claim 15, wherein said ion collecting electrodes includes at least one electrode with a characteristic selected from a group consisting of (i) an elongated cylindrical tube,(ii) an electrode with a U-shaped cross-section, (iii) an electrode with an L-shaped cross-section, (iv) an electrode with a rod-shaped cross-section, and (v) an electrode with a front section and a tail section located at an angle to the front section.

18. The electro-kinetic air transporter-conditioner as recited in claim 15, wherein the air transporter-conditioner further includes a third focus electrode located upstream of said ion emitting electrodes.

19. The electro-kinetic air transporter-conditioner as recited in claim 15, wherein the air transporter-conditioner further includes a trailing electrode located downstream of said ion collecting electrodes.

20. The electro-kinetic air transporter-conditioner as recited in claim 15, wherein two of said ion collector electrodes receive ions from principally two ion emitting electrodes and are located an equal distance downstream from said plurality of ion emitter electrodes.

21. An electro-kinetic air transporter-conditioner, comprising:
a housing having an inlet and an outlet;
a voltage generator disposed within said housing; and
an electrode assembly, electrically connected to said voltage generator, said electrode assembly creates an airflow in a downstream direction from said inlet to said outlet when said voltage generator is energized, said electrode assembly includes:
a first array of electrodes, including at least two electrodes;
a second array of electrodes, including two outermost electrodes, and at least one electrode located between said outermost electrodes, said electrodes located between said outermost electrodes being located further downstream from said first array of electrodes than said outermost electrodes.

22. The electro-kinetic air transporter-conditioner as recited in claim 21, wherein the air transporter-conditioner further includes a trailing electrode located downstream of second array of electrodes.

23. An electro-kinetic air transporter-conditioner, comprising:
a housing having an inlet and an outlet;
a voltage generator disposed within said housing;
an electrode assembly, electrically connected to said voltage generator, said electrode assembly creates an airflow in a downstream direction from said inlet to said outlet when said voltage generator is energized, said electrode assembly includes:
a first array of electrodes, including at least two electrodes;
a second array of electrodes, including two outermost electrodes, and at least one electrode located between said outermost electrodes, said electrodes located between said outermost electrodes being located closer to said outlet than said outermost electrodes.

24. The electro-kinetic air transporter-conditioner as recited in claim 23, wherein said electrodes located between said outermost electrodes are located 2-12 mm closer to said outlet than said outermost electrodes.

25. A device for conditioning air, comprising:
a housing having an inlet and an outlet;
an ion generator disposed within said housing that emits ions and that creates an airflow in a downstream direction from said inlet to said outlet, including:
a first array of ion emitter electrodes;
a second array of ion collector electrodes located downstream of, and staggered in relation to, said first array of ion emitting electrodes;
a voltage generator electrically coupled with said first array of ion emitter electrodes and said second array of ion collector electrodes;
wherein said first and second arrays are arranged such that the ions must travel further downstream to reach at least one for said ion collector electrodes than to reach the other of said ion collector electrodes in said second array of ion collector electrodes.

26. The device as recited in claim 25, wherein the device further includes at least one focus electrode upstream of said ion generator.

27. The device as recited in claim 25, wherein the device further includes at least one trailing electrode downstream of said ion generator.

28. The electro-kinetic air transporter-conditioner as recited in claim 25, wherein said array of ion emitting electrodes includes at least one electrode that shares at least one characteristic from a group consisting of(i) a rod-shaped wire, (ii) a spiral coil, (iii) a curved wire, and (iv) a flat spiral wire.

29. The electro-kinetic air transporter-conditioner as recited in claim 25, wherein said array of ion collecting electrodes includes at least one electrode with a characteristic selected from a group consisting of (i) an elongated cylindrical tube,(ii) an electrode with a U-shaped cross-section, (iii) an electrode with an L-shaped cross-section, (iv) an electrode with a rod-shaped cross-section, and (v) an electrode with a front section and having a tail section located at an angle to the front section.

30. The electro-kinetic air transporter-conditioner of claim 1 wherein all of the second electrodes are of the same configuration and size.

31. The electro-kinetic air transporter-conditioner of claim 7 wherein all of the electrodes of the second array of electrodes are of the same configuration and size.

32. The electro-kinetic air transporter-conditioner of claim 14 wherein all of the second electrodes of the second array of electrodes are of the same configuration and size.

33. The electro-kinetic air transporter-conditioner of claim 15 wherein all of the collector electrodes are of the same configuration and size.

34. The electro-kinetic air transporter-conditioner of claim 21 wherein all of the electrodes of the second array of electrodes are of the same configuration and size.

35. The electro-kinetic air transporter-conditioner of claim 23 wherein all of the electrodes of the second array of electrodes are of the same configuration and size.

36. The electro-kinetic air transporter-conditioner of claim 25 wherein all of the collector electrodes are of the same configuration and size.

37. An electro-kinetic air transporter-conditioner comprising:
a housing having an inlet and an outlet;
a voltage generator;
an electrode assembly electrically connected to said voltage generator, said electrode assembly creates an airflow from said inlet to said outlet when said voltage generator is energized, said electrode assembly including:
a first array of electrodes;
a second array of second electrodes located downstream of said first electrode; and
means for equalizing an electrical field created across the second array.

38. The electro-kinetic air transporter-conditioner of claim 37 wherein each of said second electrodes includes an upstream nose that is closer to the first electrode than the rest of the second electrodes, said equalizing means includes means for equalizing an electrical field created across the nose of the second electrodes.
